(19) United States
(12) Patent Application Publication
(10) Pub. No.: US 2007/0245163 A1
(43) Pub. Date: Oct. 18, 2007

(54) Power management in computer operating systems

(76) Inventors: Yung-Hsiang Lu, West Lafayette, IN (US); Nathaniel Pettis, Lafayette, IN (US); Changjiu Xian, West Lafayette, IN (US); Jason Ridenour, Fishers, IN (US); Jonathan Chen, West Lafayette, IN (US)

Correspondence Address: BAKER & DANIELS LLP, 300 NORTH MERIDIAN STREET, SUITE 2700, INDIANAPOLIS, IN, 46204, US

(21) Appl. No.: 11/713,889

(22) Filed: Mar. 5, 2007

Related U.S. Application Data
(60) Provisional application No. 60/779,248, filed on Mar. 3, 2006.

(51) Int. Cl. G06F 1/00

(52) U.S. Cl. 713/300

(57) ABSTRACT

An apparatus and method are provided for power management in a computer operating system. The method includes providing a plurality of policies which are eligible to be selected for a component, automatically selecting one of the eligible policies to manage the component, and activating the selected policy to manage the component while the system is running without rebooting the system.

### CROSS-REFERENCE TO RELATED APPLICATIONS

This application claims the benefit of U.S. Provisional Application Ser. No. 60/779,248, filed Mar. 3, 2006, which is expressly incorporated by reference herein.

### NOTICE

This invention was partially funded with government support under grant award number 0347466 awarded by National Science Foundation (NSF). The Government may have certain rights in portions of the invention.

### BACKGROUND AND SUMMARY OF THE INVENTION

The present invention relates to power management in computer operating systems.

The following listed references are expressly incorporated by reference herein. Throughout the specification, these references are referred to by citing to the numbers in the brackets [#].
[1] J. S. Chase, D. C. Anderson, P. N. Thakar, A. M. Vandat, and R. P. Doyle, “Managing Energy and Server Resources in Hosting Centers,” in ACM Symposium on Operating Systems Principles, 2001, pp. 103-116.
[2] C. S. Ellis, “The Case for Higher-level Power Management,” in Workshop on Hot Topics in Operating Systems, 1999, pp. 162-167.
[3] R. Neugebauer and D. McAuley, “Energy is Just Another Resource: Energy Accounting and Energy Pricing in the Nemesis OS,” in Workshop on Hot Topics in Operating Systems, 2001, pp. 59-64.
[4] H. Zeng, C. S. Ellis, A. R. Lebeck, and A. Vandat, “ECOSystem: Managing Energy As A First Class Operating System Resource,” in International Conference on Architectural Support for Programming Languages and Operating Systems, 2002, pp. 123-132.
[5] R. Joseph and M. Martonosi, “Run-time Power Estimation in High Performance Microprocessors,” in International Symposium on Low Power Electronics and Design, 2001, pp. 135-140.
[6] H. Sanchez, B. Kuttanna, T. Olson, M. Alexander, G. Gerosa, R. Philip, and J. Alvarez, “Thermal Management System for High Performance PowerPC Microprocessors,” in IEEE Compcon, 1997, pp. 325-330.
[7] Q. Zhu, F. M. David, C. Devaraj, Z. Li, Y. Zhou, and P. Cao, “Reducing Energy Consumption of Disk Storage Using Power-Aware Cache Management,” in International Symposium on High-Performance Computer Architecture, 2004, pp. 118-129.
[8] L. Benini and G. D. Micheli, “System-Level Power Optimization: Techniques and Tools,” ACM Transactions on Design Automation of Electronic Systems, vol. 5, no. 2, pp. 115-192, April 2000.
[9] F. Douglis, P. Krishnan, and B. Bershad, “Adaptive Disk Spin-down Policies for Mobile Computers,” in USENIX Symposium on Mobile and Location-Independent Computing, 1995, pp. 121-137.
[10] E.-Y. Chung, L. Benini, A. Bogliolo, Y.-H. Lu, and G. D. Micheli, “Dynamic Power Management for Nonstationary Service Requests,” IEEE Transactions on Computers, vol. 51, no. 11, pp. 1345-1361, November 2002.
[11] N. Pettis, J. Ridenour, and Y.-H. Lu, “Automatic Run-Time Selection of Power Policies for Operating Systems,” in Design Automation and Test in Europe, 2006, pp. 508-513.
[12] Y.-H. Lu and G. D. Micheli, “Comparing System-Level Power Management Policies,” IEEE Design and Test of Computers, vol. 18, no. 2, pp. 10-19, March 2001.
[13] J. Gibson, R. Kunz, D. Ofelt, M. Horowitz, J. Hennessy, and M. Heinrich, “FLASH vs Simulated FLASH,” ACM SIGPLAN Notices, vol. 35, no. 11, pp. 49-58, November 2000.
[14] J. J. Yi and D. J. Lilja, “Simulation of Computer Architectures: Simulations, Benchmarks, Methodologies, and Recommendations,” IEEE Transactions on Computers, vol. 55, no. 3, pp. 268-280, March 2006.
[15] A. Karlin, M. Manasse, L. McGeoch, and S. Owicki, “Competitive Randomized Algorithms for Nonuniform Problems,” Algorithmica, vol. 11, no. 6, pp. 542-571, June 1994.
[16] C.-H. Hwang and A. C.-H. Wu, “A Predictive System Shutdown Method for Energy Saving of Event-driven Computation,” ACM Transactions on Design Automation of Electronic Systems, vol. 5, no. 2, pp. 226-241, April 2000.
[17] L. Benini, A. Bogliolo, G. A. Paleologo, and G. D. Micheli, “Policy Optimization for Dynamic Power Management,” IEEE Transactions on Computer-Aided Design of Integrated Circuits and Systems, vol. 18, no. 6, pp. 813-833, June 1999.
[18] T. Simunic, L. Benini, P. Glynn, and G. D. Micheli, “Dynamic Power Management for Portable Systems,” in International Conference on Mobile Computing and Networking, 2000, pp. 11-19.
[19] Z. Ren, B. H. Krogh, and R. Marculescu, “Hierarchical Adaptive Dynamic Power Management,” IEEE Transactions on Computers, vol. 54, no. 4, pp. 409-420, April 2005.
[20] Q. Qiu, Q. Wu, and M. Pedram, “Dynamic Power Management of Complex Systems Using Generalized Stochastic Petri Nets,” in Design Automation Conference, 2000, pp. 352-356.
[21] Advanced Configuration Power Interface, “http://www.acpi.info.”
[22] Microsoft Corporation. (2001, December) OnNow Pow. Mgmt. Architecture for Applications. [Online]. Available: http://www.microsoft.com1whdc/archive/OnNowApp.mspx
[23] D. Brownell, “Linux Kernel 2.6.17 Source: Documentation/power/devices.txt,” http://www.kernel.org, July 2006.
[24] L. Cai and Y.-H. Lu, “Joint Power Management of Memory and Disk,” in Design, Automation, and Test in Europe, 2005, pp. 86-91.
[25] X. Li, Z. Li, F. David, P. Thou, Y. Zhou, S. Adve, and S. Kumar, “Performance Directed Energy Management for Main Memory and Disks,” in International Conference on Architectural Support for Programming Languages and Operating Systems, 2004, pp. 271-283.
[26] N. Pettis, L. Cai, and Y.-H. Lu, “Statistically Optimal Dynamic Power Management for Streaming Data,” IEEE Transactions on Computers, vol. 55, no. 7, pp. 800-814, July 2006.
[27] P. Zhou, V. Pandey, J. Sundaresan, A. Raghuraman, Y. Zhou, and S. Kumar, “Dynamic Tracking of Page Miss Ratio Curve for Memory Management,” in International Conference on Architectural Support for Programming Languages and Operating Systems, 2004, pp. 177-188.
[28] Q. Zhu, A. Shankar, and Y. Zhou, “PB-LRU: A Self-tuning Power Aware Storage Cache Replacement Algorithm for Conserving Disk Energy,” in International Conference on Supercomputing, 2004, pp. 79-88.
[29] R. Love, Linux Kernel Development. Sams Publishing, 2004.
[30] A. Chou, J. Yang, B. Chelf, S. Hallem, and D. Engler, “An Empirical Study of Operating Systems Errors,” in ACM Symposium on Operating Systems Principles, 2001, pp. 73-88.
[31] J. H. Saltzer, D. P. Reed, and D. D. Clark, “End-To-End Arguments in System Design,” ACM Transactions on Computer Systems, vol. 2, no. 4, pp. 277-288, November 1984.
[32] J. Levon and P. Elie. OProfile. [Online]. Available: http://oprofile.sourceforge.net
[33] O. Celebican, T. S. Rosing, and V. J. M. III, “Energy Estimation of Peripheral Devices in Embedded Systems,” in Great Lakes symposium on VLSI, 2004, pp. 430-435.
[34] T. L. Cignetti, K. Komarov, and C. S. Ellis, “Energy Estimation Tools for The Palm,” in International Workshop on Modeling, Analysis and Simulation of Wireless and Mobile Systems, 2000, pp. 96-103.
[35] K. I. Farkas, J. Flinn, G. Back, D. Grunwald, and J. M. Anderson, “Quantifying the Energy Consumption of a Pocket Computer and a Java Virtual Machine,” in International Conference on Measurements and Modeling of Computer Systems, 2000, pp. 252-263.
[36] T. Li and L. K. John, “Run-time Modeling and Estimation of Operating System Power Consumption,” in ACM SIGMETRICS International Conference on Measurement and Modeling of Computer Systems, 2003, pp. 160-171.
[37] C. Ruemmler and J. Wilkes, “An Introduction to Disk Drive Modeling,” IEEE Computer, vol. 27, no. 3, pp. 17-28, March 1994.
[38] J. Zedlewski, S. Sobti, N. Garg, F. Zheng, A. Krishnamurthy, and R. Wang, “Modeling Hard-Disk Power Consumption,” in Conference on File and Storage Technologies, 2003, pp. 217-230.
[39] R. Golding, P. Bosch, and J. Wilkes, “Idleness Is Not Sloth,” in USENIX Winter Conference, 1995, pp. 201-212.
[40] Y. Fei, L. Zhong, and N. K. Jha, “An Energy-Aware Framework for Coordinated Dynamic Software Management in Mobile Computers,” in Modeling, Analysis, and Simulation of Computer and Telecommunications Systems, 2004, pp. 306-317.
[41] J. Flinn and M. Satyanarayanan, “Energy-Aware Adaptation for Mobile Applications,” in ACM Symposium on Operating Systems Principles, 1999, pp. 48-63.
[42] W. Yuan and K. Nahrstedt, “Energy-Efficient Soft Real-Time CPU Scheduling for Mobile Multimedia Systems,” in ACM Symposium on Operating Systems Principles, 2003, pp. 149-163.

Exhibits A and B attached to the present application are also expressly incorporated herein reference. Exhibit A is an article entitled “A Homogeneous Architecture for Power Policy Integration in Operating Systems”. Exhibit B is an article entitled “Workload Adaptation with Energy Accounting in a Multi-Process Environment”.

Reducing energy consumption is an important issue in modern computers. A significant volume of research has concentrated on operating-system directed power management (OSPM). One primary focus of previous research has been the development of OSPM policies. An OSPM policy is an algorithm that chooses when to change a component's power states and which power states to use. Existing studies on power management make an implicit assumption: only one policy can be used to save power.

The present invention provides a plurality of OSPM policies that are eligible to be selected to manage a hardware component, such as an I/O device. The illustrated power management system then automatically selects the best policy from a power management standpoint and activates the selected policy for a particular component.

New policies may be added using the architecture of an illustrated embodiment described herein. The system and method compares the plurality of eligible policies to determine which policy can save more power for a current request pattern of a particular component. The eligible policy with the lowest average power value based on the current request pattern of the particular component is selected to manage the component and then automatically activated. The previously active policy is deactivated for the particular component.

The system and method of the present invention permits OSPM policies to be added, compared, and selected while a system is running without rebooting the system. Therefore, the present system and method allows easier implementation and comparison of policies. In the illustrated embodiment, the available policies are compared simultaneously so repeatable workloads are unnecessary.

Another approach to reducing energy consumption in computers is the use of dynamic power management (DPM). DPM has been extensively studied in recent years. One approach for DPM is to adjust workloads, such as clustering or eliminating requests, as a way to trade-off energy consumption and quality of services. Previous studies focus on single processes. However, when multiple concurrently running processes are considered, workload adjustment must be determined based on the interleaving of the processes' requests. When multiple processes share the same hardware component, adjusting one process may not save energy.

In another illustrated embodiment of the present invention, energy responsibility is assigned to individual processes based on how they affect power management. The assignment is used to estimate potential energy reduction by adjusting the processes. An illustrated embodiment uses the estimation to guide runtime adaptation of workload behavior. Results from experiments are included to demonstrate that the illustrated embodiment saves energy and improves energy efficiency.

The above mentioned and other features of this invention, and the manner of attaining them, will become more apparent and the invention itself will be better understood by reference to the following description of illustrated embodiments of the invention.

A significant volume of research has concentrated on operating-system directed power management (OSPM). The primary focus of previous research has been the development of OSPM policies. Under different conditions, one policy may outperform another and vice versa. Hence, it is difficult, or even impossible, to design the “best” policy for all computers. In the system and method of the present invention, the best policies are selected at run-time without user or administrator intervention. Policies are illustratively compared simultaneously and improved iteratively without rebooting the system. In the system and method of the present invention, the energy savings of several policies is improved by up to 41 percent.

Operating systems (OSs) manage resources, including processor time, memory space, and disk accesses. Due to the growing popularity of portable systems that require long battery life, energy has become a crucial resource for OSs to manage [1]-[4]. Power management is also important in high-performance servers because performance improvements are limited by excessive heat [5][7]. Finding better policies has been the main focus of OSPM research in recent years [8]. A policy is an algorithm that chooses when to change a component's power states and which power states to use.

Existing studies on power management assume that only one policy can be used to save power and focus on finding the best policies for unique request patterns. Although some policies allow their parameters to be adjusted at run-time [9], [10], the algorithms remain the same. Previous studies demonstrate that significantly different policies may be needed to achieve better power savings in different scenarios. Most studies evaluate their policies using a single hardware component. For example, hard disks and CD-ROM drives are both block devices, but their workload behaviors are different.

The embodiments disclosed below are not intended to be exhaustive or to limit the invention to the precise forms disclosed in the following detailed description. Rather, the embodiments are chosen and described so that others skilled in the art may utilize their teachings.

Automatic Run-Time Selection of Power Policies for Operating Systems

In one illustrated embodiment, homogeneous requirements are established for all OSPM policies so they can be easily integrated into the OS and selected at run-time. This homogeneous architecture is described herein as the Homogeneous Architecture for Power Policy Integration (HAPPI). In the illustrated embodiment, HAPPI currently supports power policies for disk, DVD-ROM, and network devices but can easily be extended to support other I/O devices.

Each component or device has a set of OSPM policies that are capable of managing the device. A policy is said to be “eligible” to manage a device if it is in the device's policy set. A policy becomes eligible when it is loaded into the OS and is no longer eligible when it is removed from the OS. The policy is considered “active” if it is selected to manage the power states of a specific device by HAPPI. Each device is assigned only one active policy at any time. However, a policy may be active on multiple devices at the same time by creating an instance of the policy for each device. When a policy is activated, it obtains exclusive control of the device's power state. The policy is responsible for determining when the device should be shut down and requesting state changes. An active policy may update its predictions and request device state changes on each device access or a periodic timer interrupt. The set always includes a “null policy” that keeps the device in the highest power state.

As discussed above, the illustrated embodiment permits OSPM policies to be added, compared, and selected while a system is running without rebooting the system. Therefore, the best eligible policy is selected to manage the particular device and then automatically activated to reduce power consumption. Any previously active policy is deactivated for the particular device.

Details of the policy selection process are described in Exhibit A. To accomplish this policy selection at run-time, each policy includes an estimation function (also called an “estimator”) to provide a quantitative measure of the policy's ability to control a device. An estimator accepts a list of recent device accesses from HAPPI. The length of this list is determined experimentally. For the illustrated version of HAPPI, the list contains eight accesses, with disk and DVD accesses closer than 1 s and network accesses closer than 100 ms merged together into a single access. The accesses are merged because the Linux kernel issues several accesses in rapid succession, although they would be serviced as continuous request from the device.

The estimator determines what decision would have been made after each access if the policy had been controlling that device during the trace. The specific decision is entirely dependent upon the policy and not influenced by HAPPI. The energy consumption and access latency for this decision are added to a total. Once all accesses have been handled, the estimator determines how much energy would have been consumed between the last access and the current time and adds this amount to the total energy. The total energy consumption and device access latency constitute the “estimate.” This value is returned to the evaluator to determine the best policy for the current workload.

To compute energy consumption, the illustrated embodiment uses a state-based model. The amount of time in a state is multiplied by the power to compute the amount of energy consumed in that state. The state transition energy is added for each power state transition. To compute access latency, the illustrated embodiment uses the amount of time required to awaken the device from a sleeping state if the device was asleep before the access occurred. If the device was awake, the illustrated embodiment does not add latency because the latency is insignificant compared to the amount of time required to awaken the device.

As discussed above, the present system and method provide automatic policy selection. Instead of choosing one policy in advance, a group of policies are eligible at run-time, and one is selected in response to the changing request patterns. This is especially beneficial for a general—purpose system, such as a laptop computer, where usage patterns can vary dramatically when the user executes different programs.

The system and method of the present invention utilizes automatic policy selection to help designers improve policies and select the proper policy for a given application. Several fundamental challenges arise for automatic policy selection. First, a group of policies must be eligible to be selected. A Homogeneous Architecture for Power Policy Integration (HAPPI) is illustratively uses as the framework upon which new policies can be easily added without modifying the OS kernel or rebooting the system. When power management is conducted by OSs, changing a policy requires rebooting the system [12]. Second, eligible policies must be compared to predict which policy can save the most energy for the current request pattern. Third, the best eligible policy must be selected to manage a hardware component and the previous policy must stop managing the same component.

In the system and method of the present invention, new policies can be added and selected without rebooting the system. This allows researchers to implement policies in a commodity OS, namely Linux. Several studies [13], [14] have demonstrated that simulations suffer from poor accuracy and long runtimes. The present invention simplifies the implementation of policies and compares these policies simultaneously, considering multiple processes, nondeterminism, actual OS behavior, and real hardware. Simultaneous comparison is important because repeatable workloads are difficult to produce [14]. Furthermore, experiments may be run in real-time rather than long-running, detailed simulations.

Dynamic Power Management

Most users are familiar with power management for block access devices, such as hard disks. Users can set the timeout values in Windows' Control Panel or using Linux's hdparm command. This is the most widely-used “timeout policy.” Karlin et al. [15] propose a 2-competitive timeout algorithm, where the timeout value is the break-even time of the hardware device. The breakeven time is defined as the amount of time a device must be shut down to save energy. Douglis et al. [9] suggest an adaptive timeout scheme to reduce the performance penalties for state transitions while providing energy savings. Hwang and Wu [16] use exponential averages to predict idleness and shut down the device immediately after an access when the predicted idleness exceeds the break-even time. Several studies focus on stochastic optimization using Markov models [10], [17]-[19] and generalized stochastic Petri Nets [20]. However, OS behaviors, such as deferred work, cause these policies to mispredict consistently. We will describe in Section V how HAPPI may be used to improve predictions for these policies.

Operating System-Directed Power Management

The Advanced Configuration and Power Interface (ACPI) specification [21] defines a platform-independent interface for power management. ACPI describes the power consumption of devices and provides a mechanism to change the power states. However, ACPI requires an operating system-directed power manager to implement policies. Microsoft Windows' OnNow API [22] uses ACPI to allow individual devices' power states to be controlled by the device driver, which presumably implements a single policy as discussed herein above. OnNow provides a mechanism to set the timeout values and the device state after timeout, but policies cannot be changed without rebooting. Linux handles power management similarly using ACPI [23] but requires user-space applications with administrative privilege, such as hdparm, to modify timeouts and policies. In the present system and method, policies manage power states above the driver level because a significant number of policies require cooperation between devices [7], [24]-[28] that cannot be achieved at the device driver level. An embodiment of the system and method of the present invention implements policies above the device driver levels so that single area multi-device policies may be implemented. Therefore, complex policies may be implemented without rebooting the system and operate on multiple devices simultaneously.

The present system and method dynamically selects a single policy from a set of policies for each device without rebooting the system, allowing experiments of new policies without disrupting system availability. This is particularly useful in high-performance servers. The present system provides a simple, modular interface that simplifies policy implementation and experimentation, allowing OS designers and policy designers to work independently. That is, policy designers can experiment with different policies without modifying the core OS, and power management is modular enough that it can be removed without impacting OS designers.

### DESCRIPTION OF THE DRAWINGS

This design specifies homogeneous requirements for all policies so they can be easily integrated into the OS and selected at run-time. Homogeneous requirements are necessary to allow significantly different policies to be compared by the OS. This architecture is referred to as the Homogeneous Architecture for Power Policy Integration (HAPPI). HAPPI is currently capable of supporting power policies for disk, CD-ROM, and network devices but can easily be extended to support other I/O devices. To implement a policy in HAPPI, the policy designer may provide: 1) A function that predicts idleness and controls a device's power state, and 2) A function that accepts a trace of device accesses, determines the actions the control function would take, and returns the energy consumption and access delay from the actions.

FIG. 1 is a block diagram illustrating the organization of the present system 10 within a Linux kernel. User-space applications 12, 14 issue device requests through file descriptors and sockets. Both of these request types are serviced by the virtual file system (VFS) 16. The HAPPI system 18 records each of these accesses, forwards the access to the device driver 20, and issues a notification to the active policy 22. The active policy 22 is selected by an evaluator 24 by using the estimator functions for all policies. The active policy 22 has the exclusive right to command the power states of the device 26. A run-time Power Management Interface 25 suspends or resumes the active policy 22 to control devices 26 through drivers 20. A policy may update its predictions and request device state changes on each device access or a periodic timer interrupt.

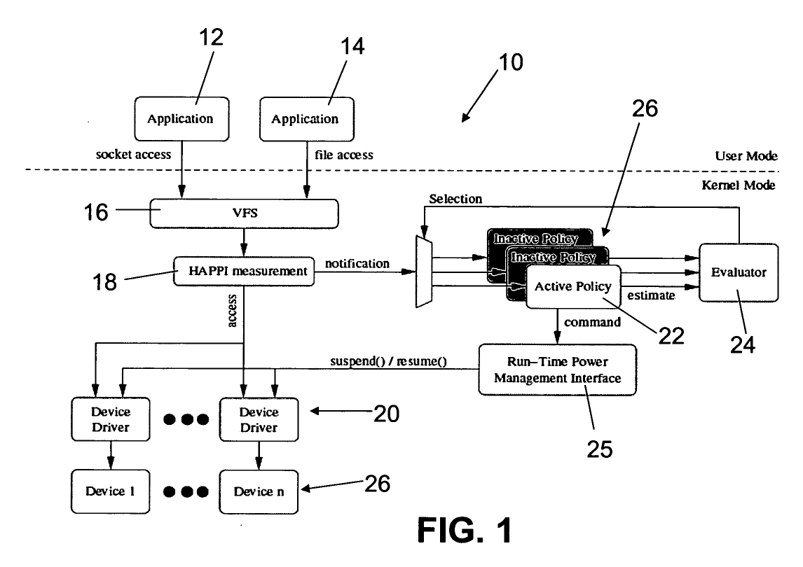

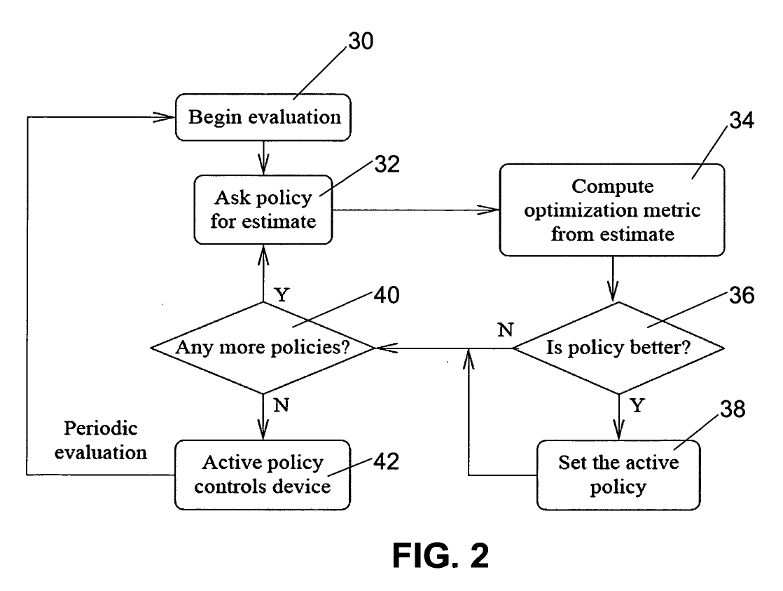

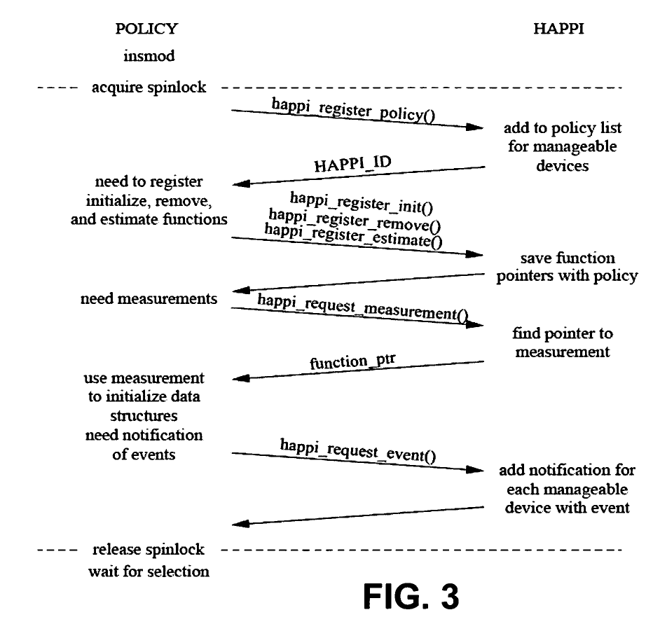

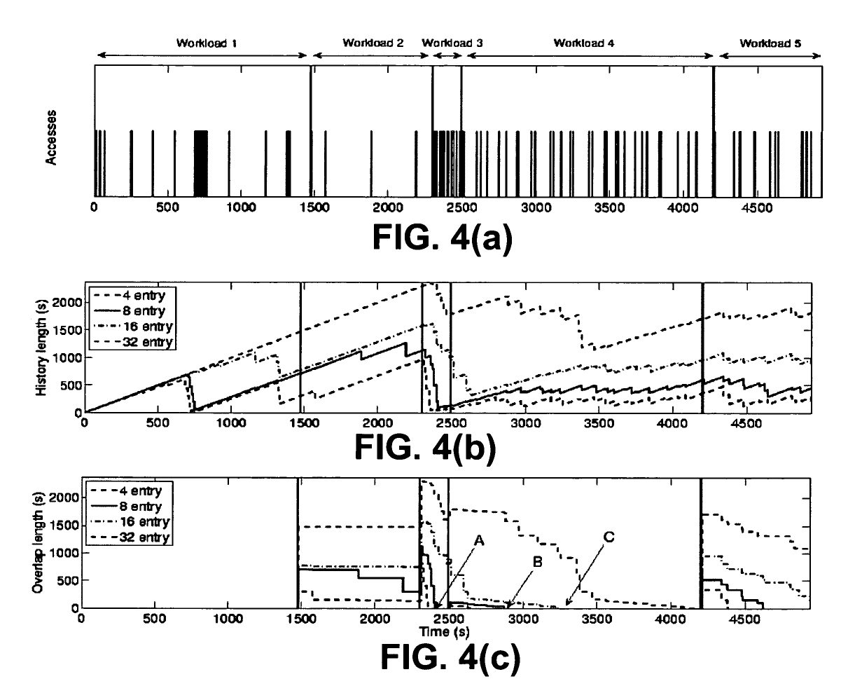

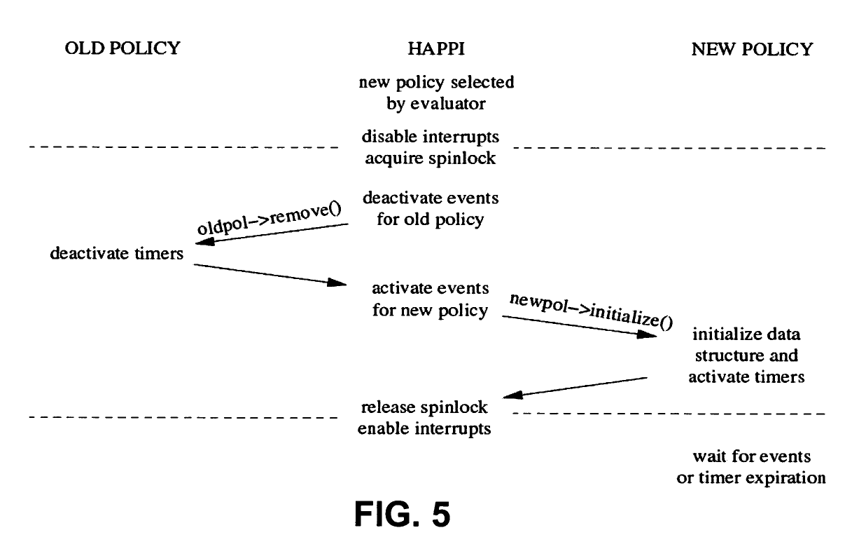

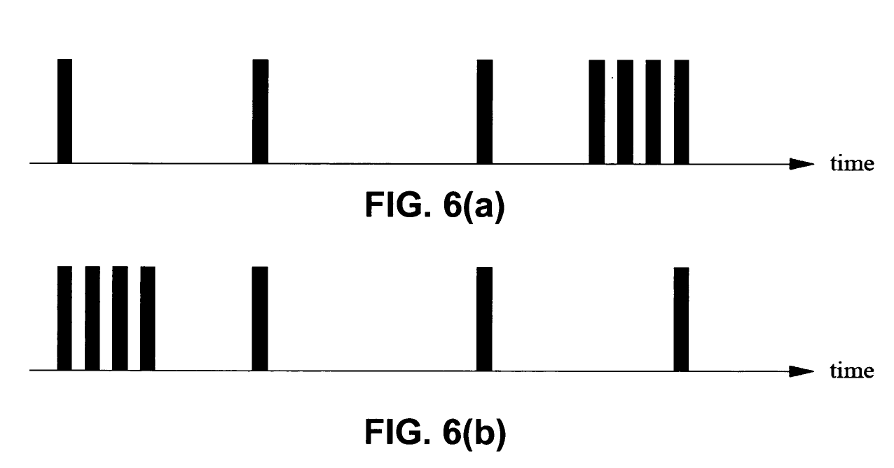

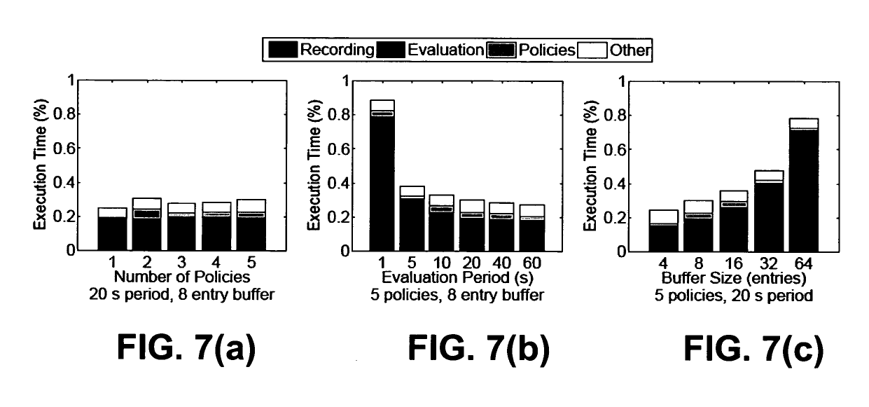

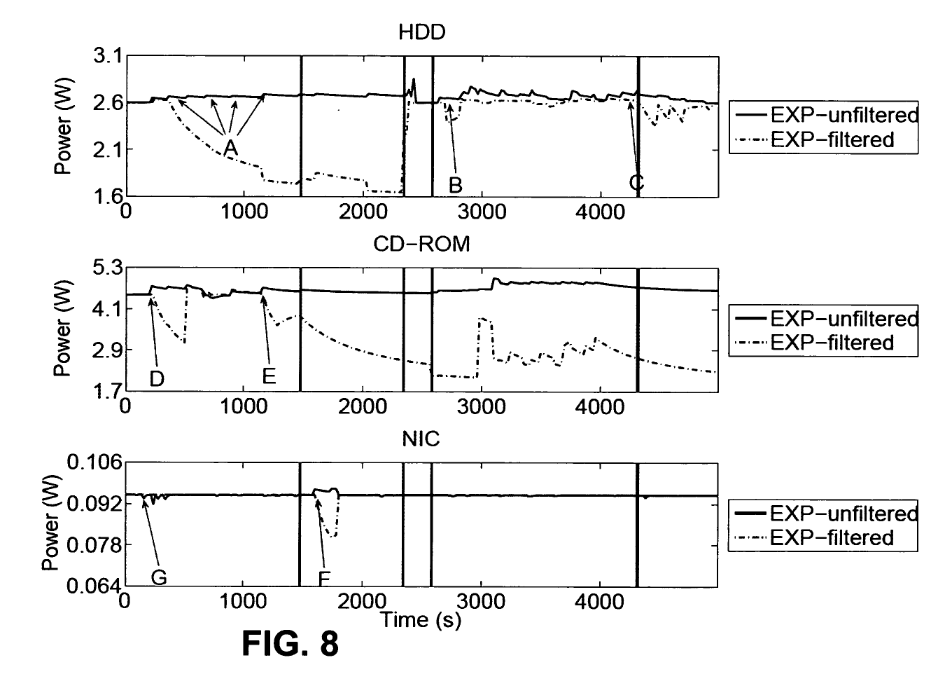

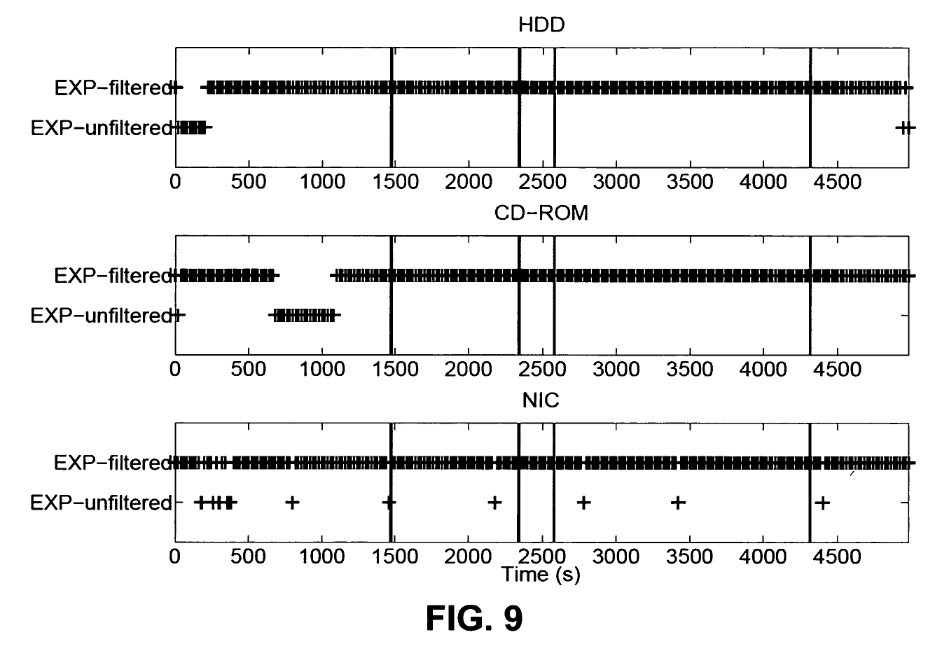

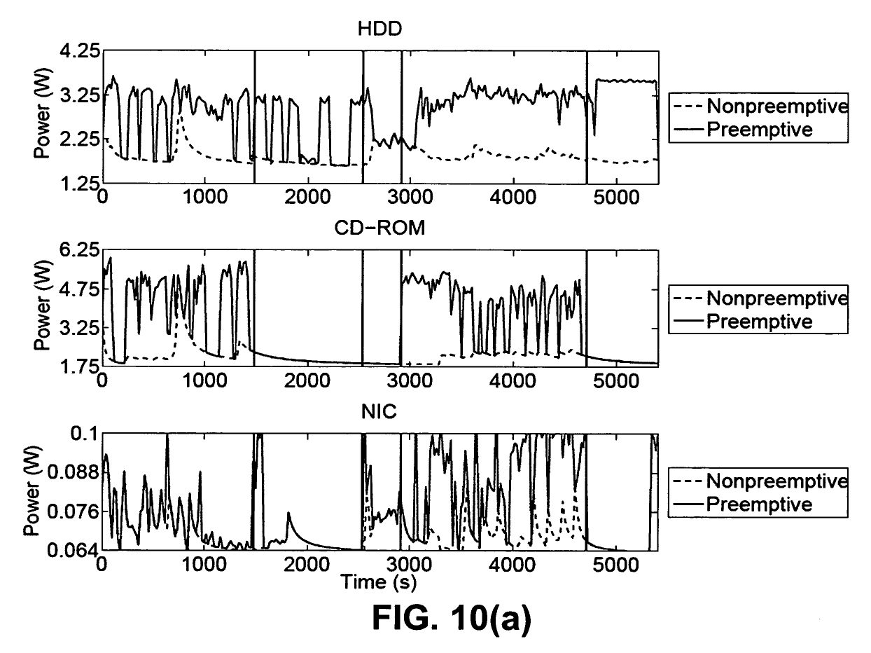

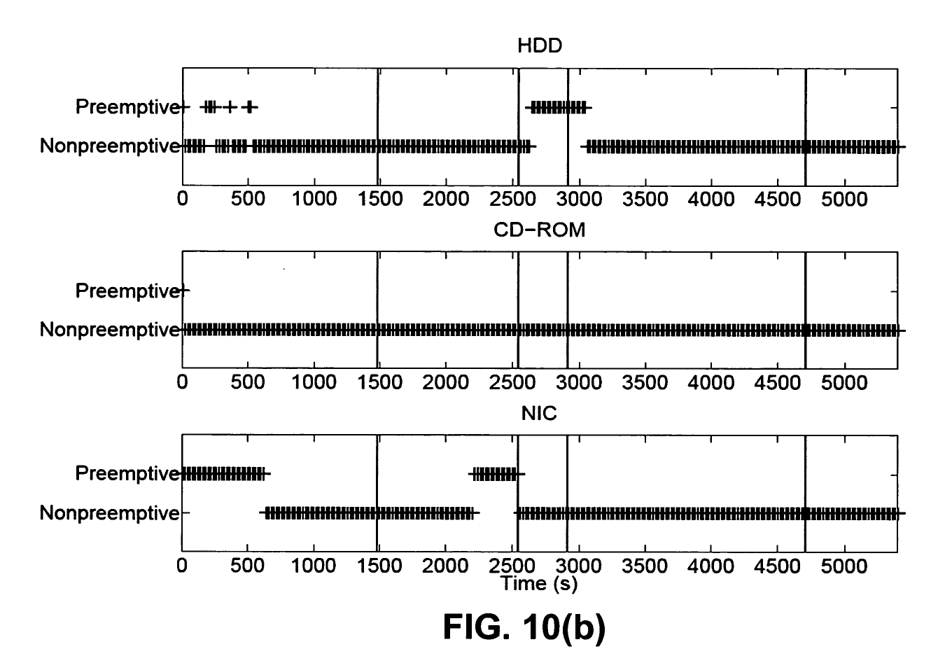

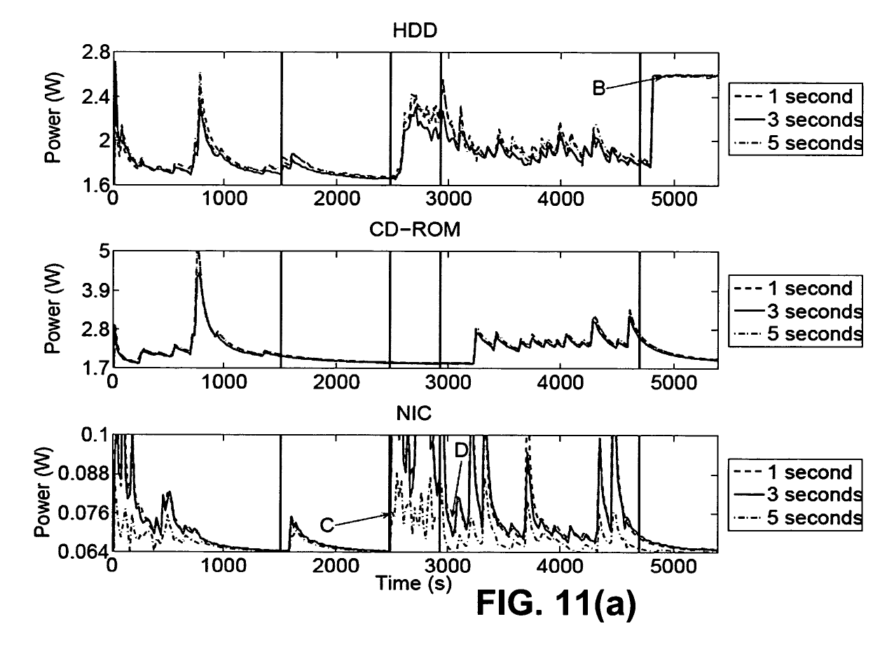

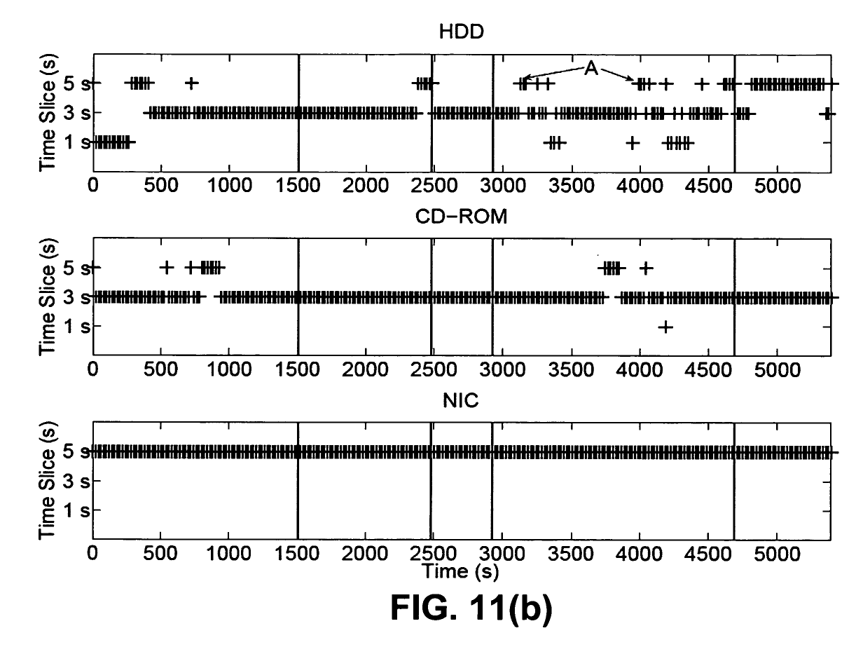

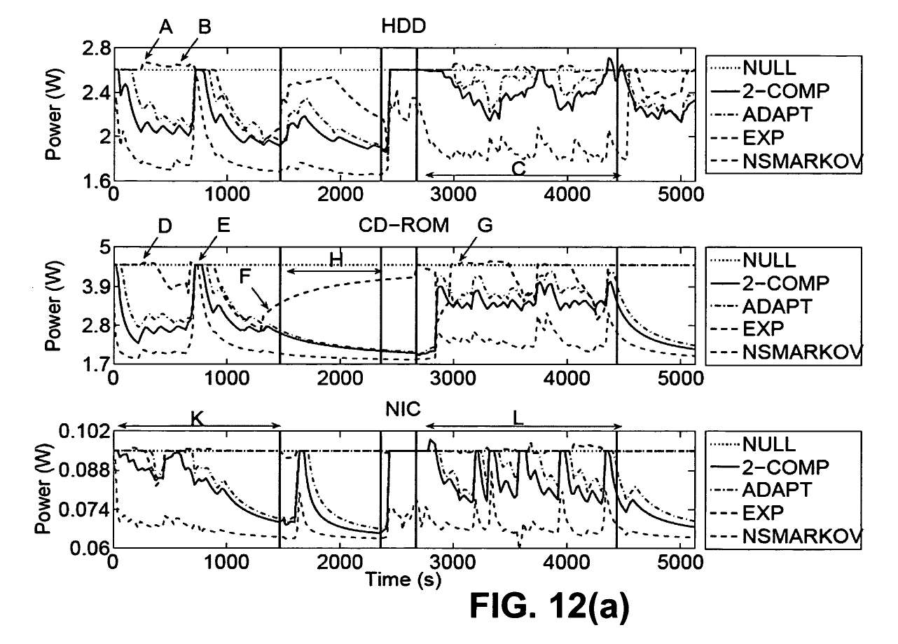

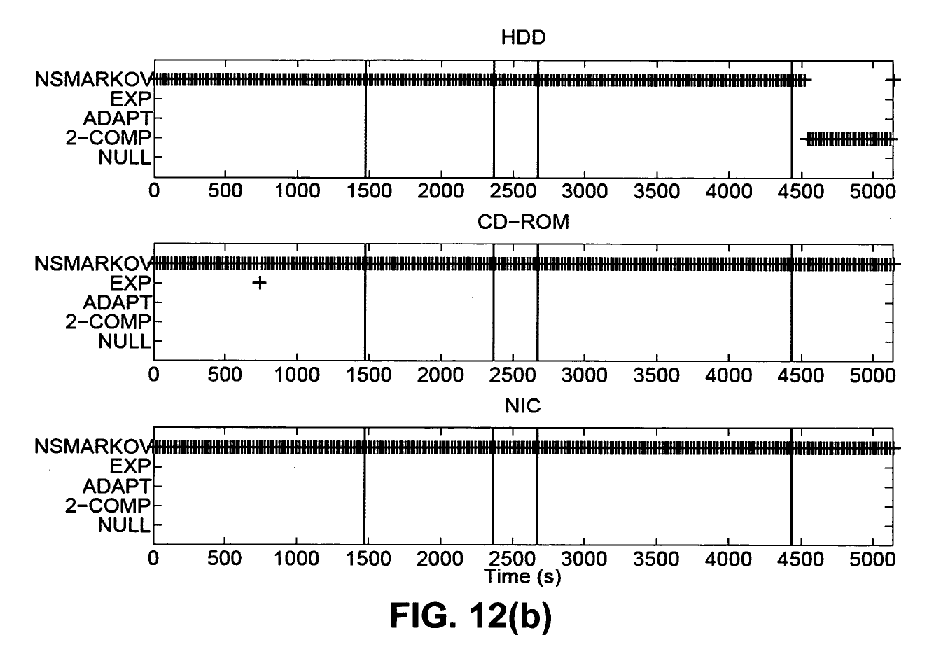

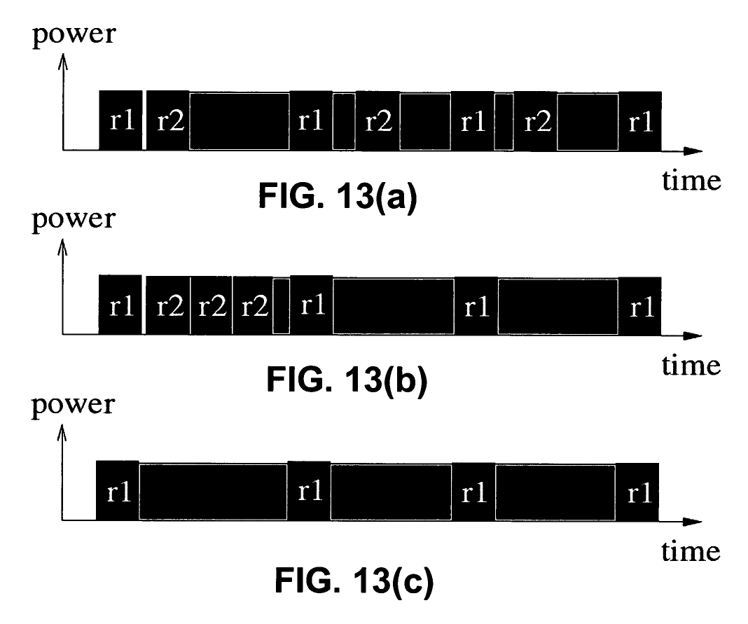

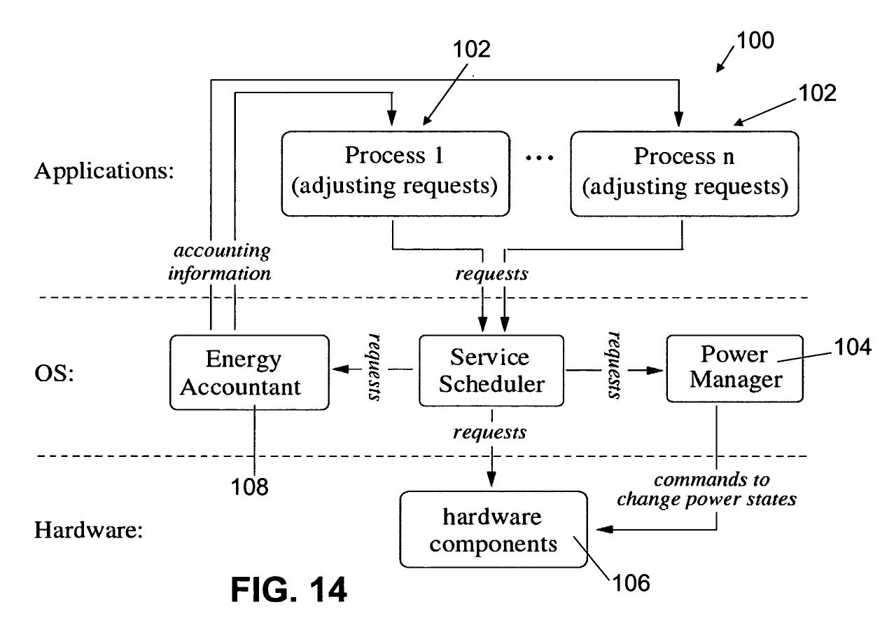

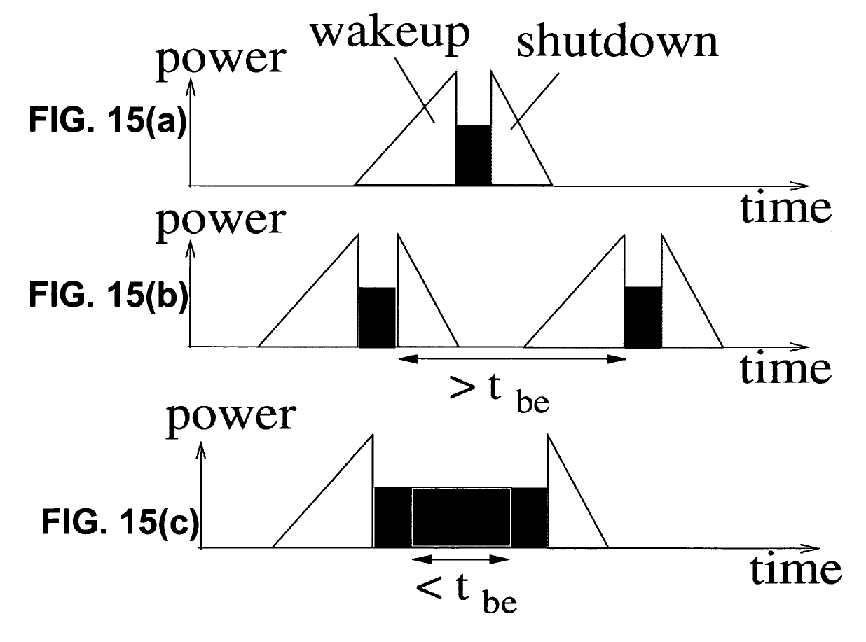

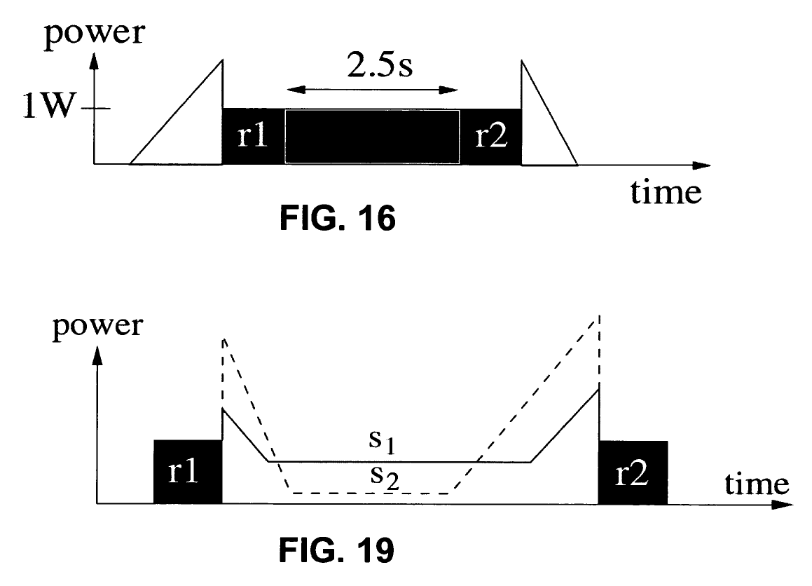

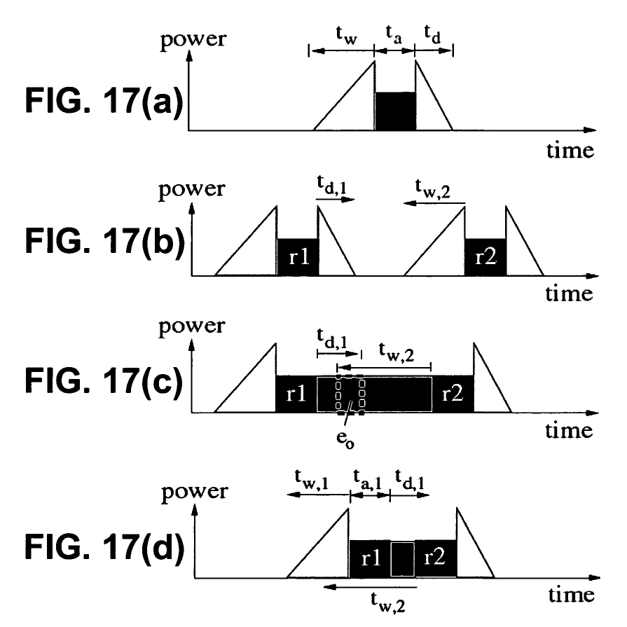

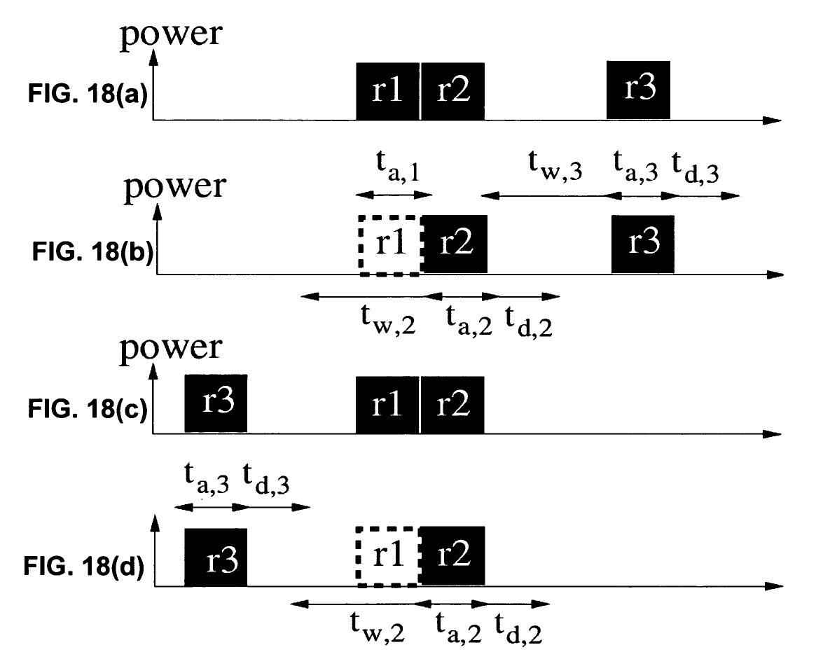

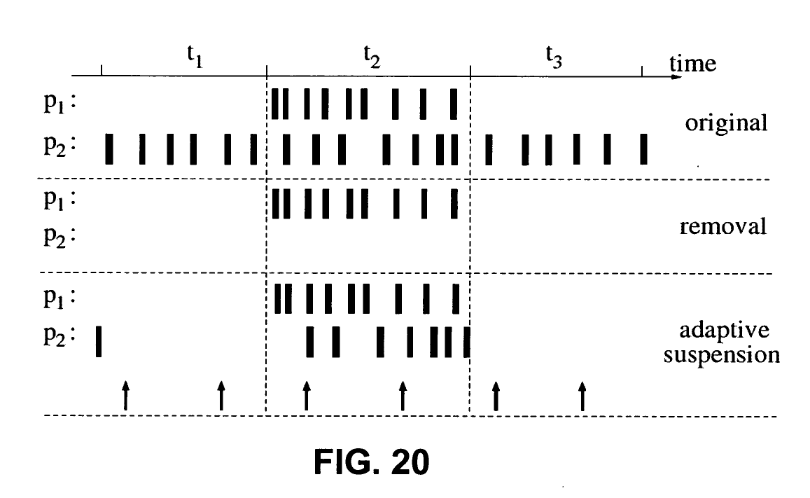

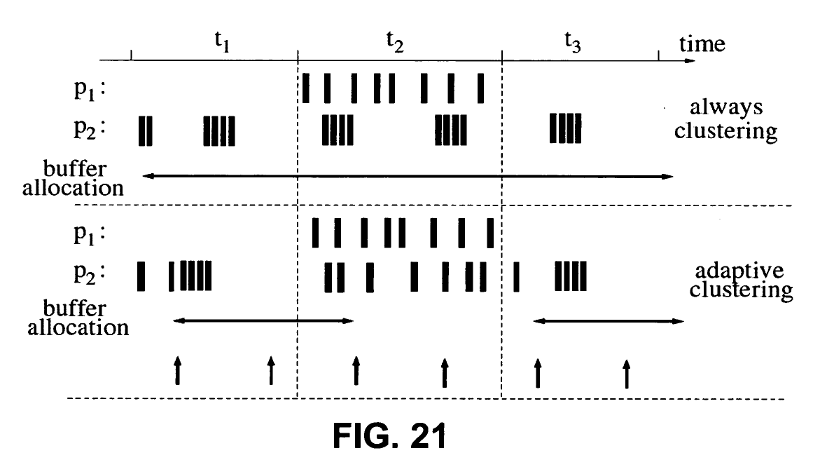

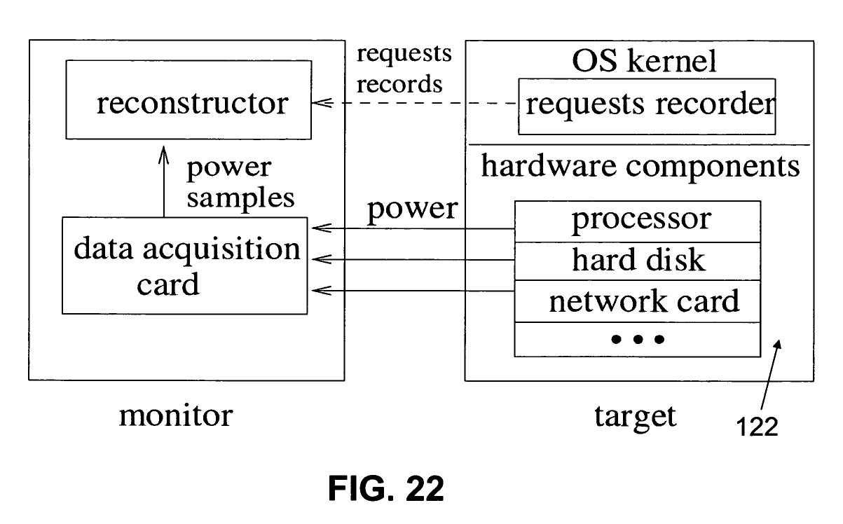

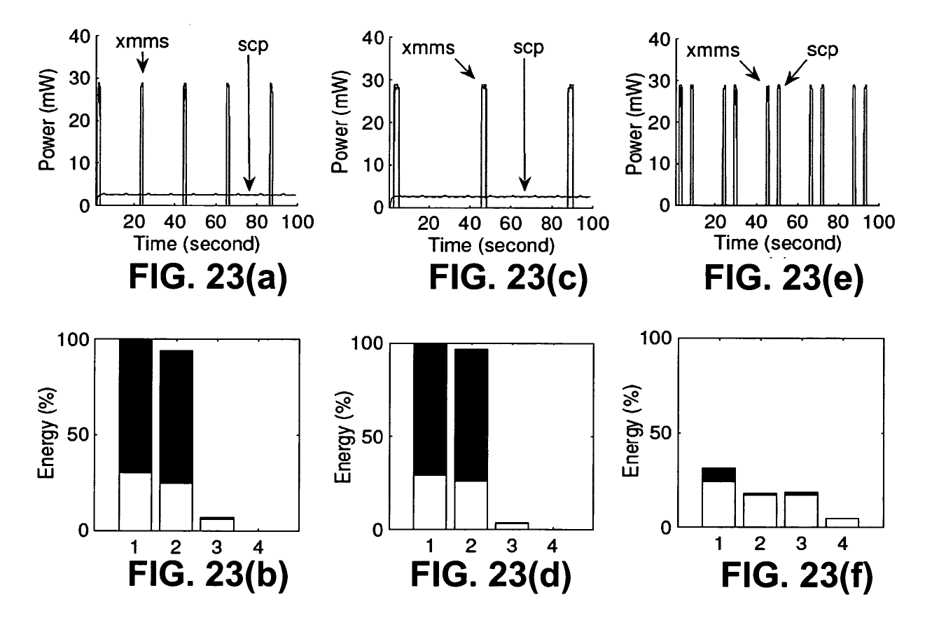

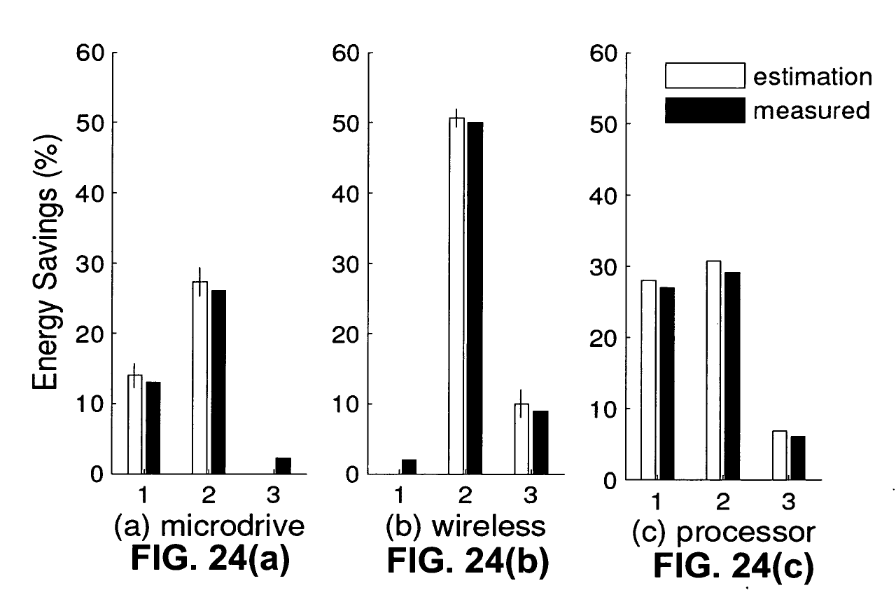

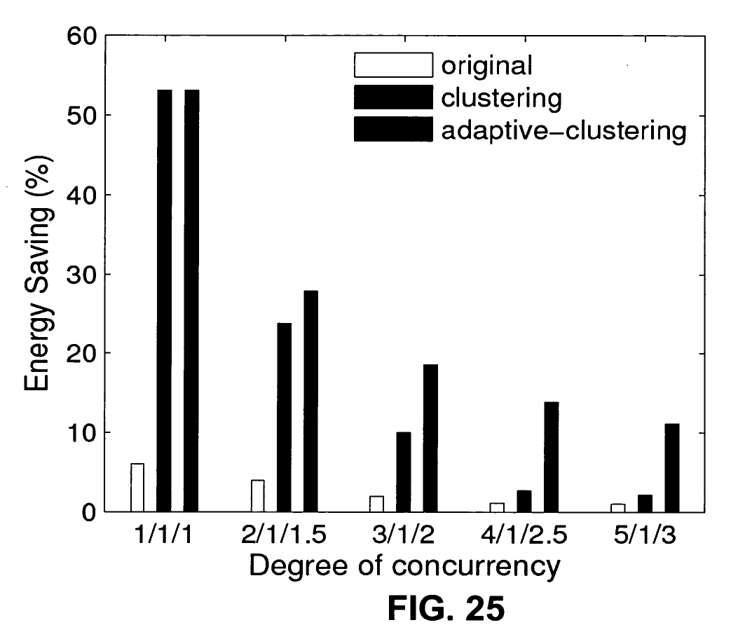

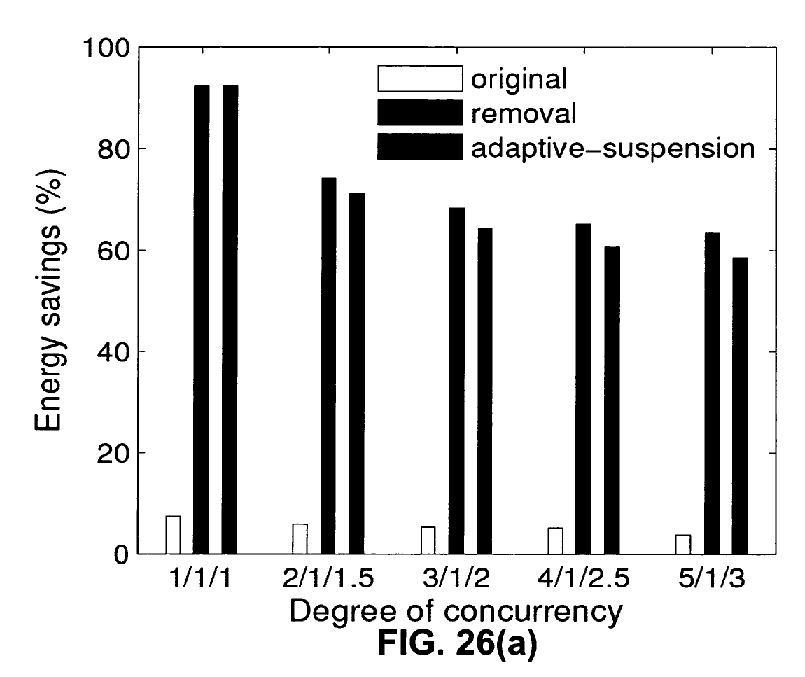

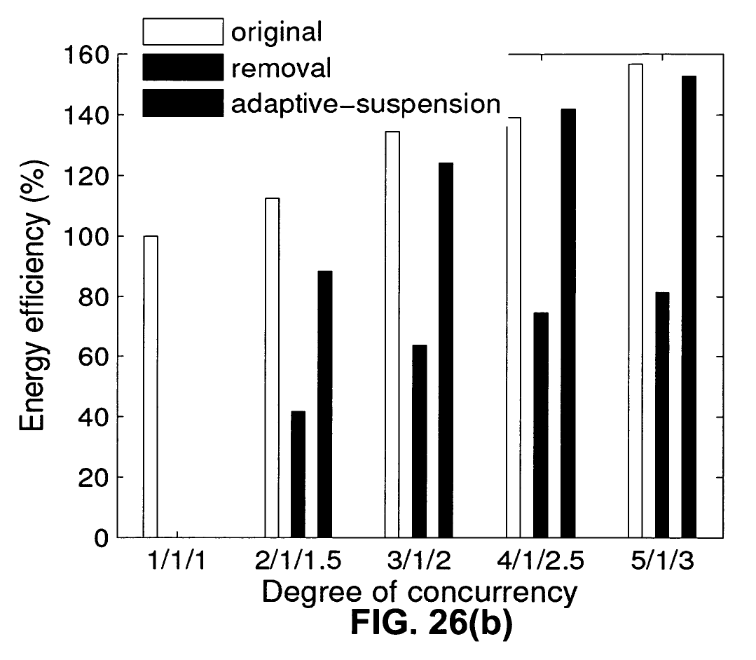

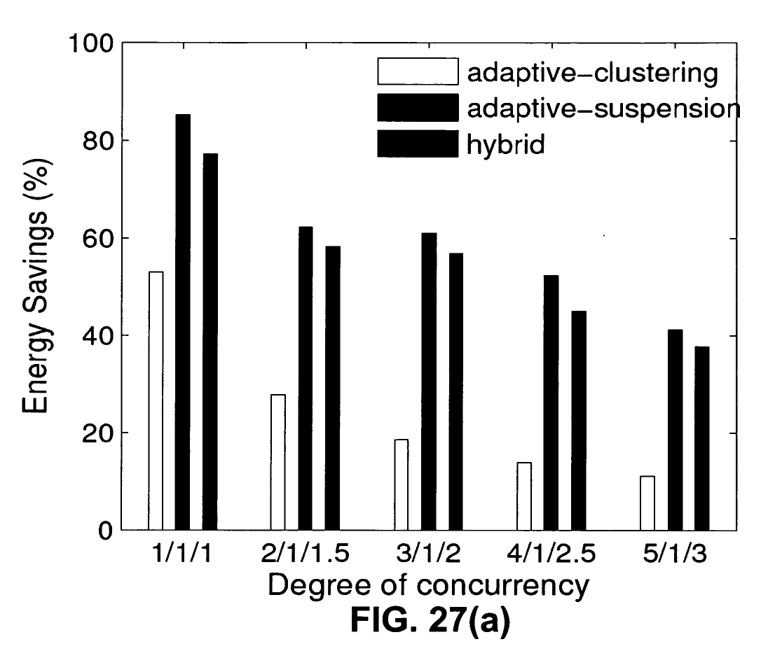

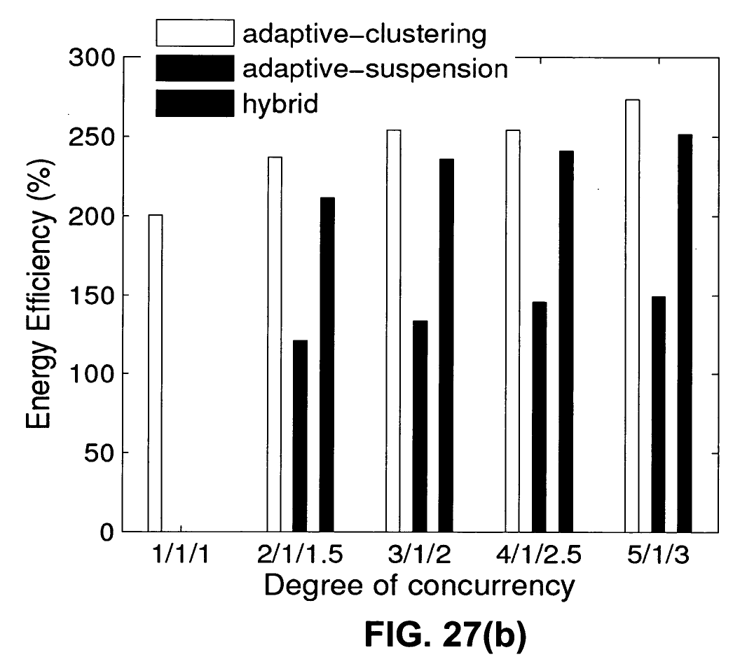

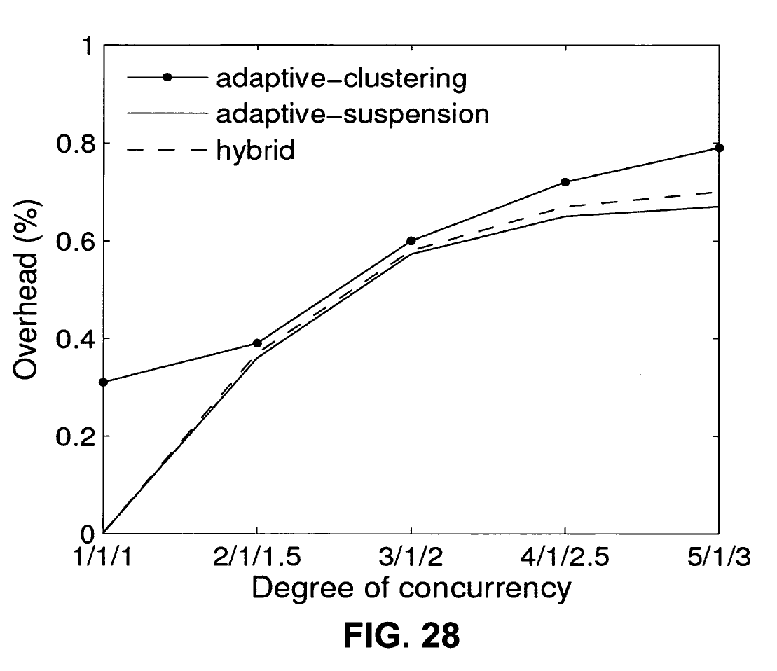

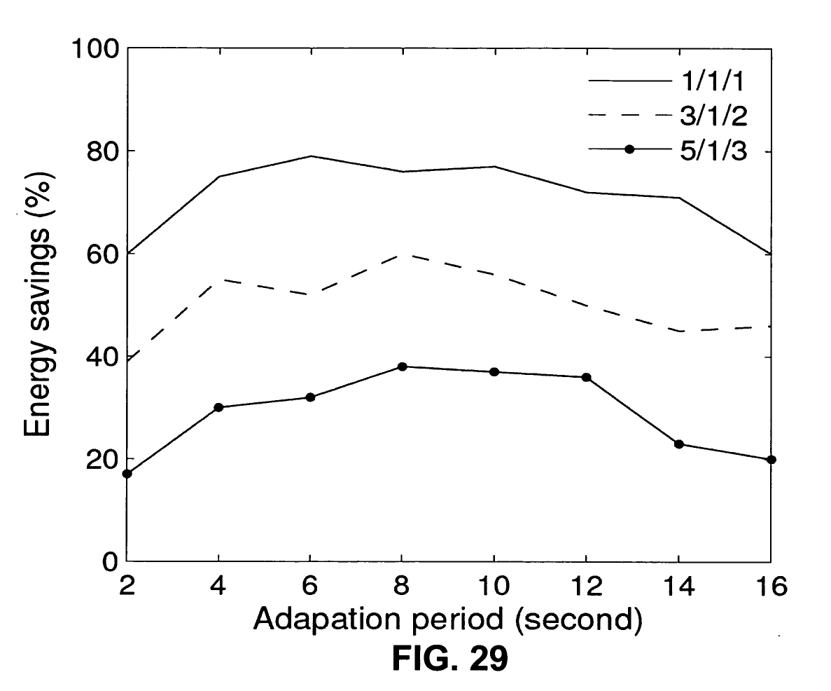

### POLICY SET

Each device 26 has a set of policies 26 that are capable of managing the device 26. A policy 26 is said to be eligible to manage a device if the policy is in the device's policy set. A policy illustratively becomes eligible when it is loaded into the OS as a kernel module and is no longer eligible when it is removed from the OS. The policy is active if it is selected to manage the power states of a specific device by HAPPI. Each device 26 is assigned only one active policy 22 at any time. However, a policy may be active on multiple devices 26 at the same time by creating data structures for each device within the policy and multiplexing HAPPI function calls. When a policy is activated, it obtains exclusive control of the device's power state. The policy is responsible for predicting idleness, determining when the device should be shut down, and requesting state changes. An active policy 22 may update its predictions and request device state changes on each device access or after a specified timeout.

Measuring Device Accesses

Policies monitor device accesses to predict idleness and determine when to change power states. We refer to the data required by policies to make decisions as measurements. One such measurement is a trace of recent accesses. Policies use access traces to make idleness predictions. Whenever the device is accessed, the present invention captures the size and the time of the access. An access trace is a measurement, but not all measurements are traces. More advanced policies may require additional measurements, such as a probability distribution of accesses. The present system and method also records the energy and the delay for each device. Energy is accumulated periodically and after each state transition. The present invention defines delay as the amount of time that an access waits for a device to awaken. Delay is only accumulated for a process's first access while sleeping or awakening because Linux prefetches adjacent blocks on each access. Delay may be used to determine power management's impact on system performance.

Policy Selection

Policy selection is performed by the evaluator 24 and is illustrated in FIG. 2 beginning at block 30. When the evaluator is triggered, it asks all eligible policies to provide an estimate of potential behavior for the current measurements. The system asks the first eligible policy for an estimate of block 32. An estimate consists of energy consumption and total delay for the measurement data and quantifies a policy's ability to manage the device. To accomplish this, each policy must provide an estimation function that uses HAPPI's measurement data to analyze what decisions the policy would have made if it were active when the measurements were taken. The energy and the delay for these decisions are computed by the estimation function and returned to the evaluator 24. Estimates are brief simulations of policies. Gibson et al. [13] note that simulation error is significant but observe that simulations are good at modeling trends. This error is acknowledged and the word “estimate” is used herein to emphasize that an exact computation of energy consumption is not required. The accuracy of estimates is considered below.

After evaluator 24 asks for a policy estimate for the first eligible policy at block 32, the evaluator 24 computes an optimization metric from the estimate as illustrated at block 34. Evaluator 24 determines whether the currently evaluated policy is better than the previously stored policy (or the null policy as discussed below) as illustrated at block 36. If so, the currently evaluated policy is set as the active policy 22 as illustrated at block 38. If the currently evaluated policy is not better than the previously stored policy, evaluator 24 next determines whether there are any more policies to evaluate as illustrated at block 40. If so, the evaluator 24 asks for a policy estimate on the next eligible policy at block 32 and repeats the cycle discussed above. If no more policies are eligible at block 40, evaluator 24 permits the active policy 22 to control the device 26 as illustrated at block 42. A periodic evaluation of the eligible policies occurs at each device access or after a specific time out.

As discussed above, an active policy 22 for each device is selected by the evaluator 24 after the evaluator receives estimates from all eligible policies. The evaluator 24 selects each active policy 22 by choosing the best estimate for an optimization metric, such as total energy consumption or energy-delay product as illustrated at block 34. If another policy's estimate is better than the currently active policy at block 36, the inferior policy is deactivated and returned to the set of eligible policies. The superior policy is activated at block 38 and assumes control of the device's energy management. Otherwise, the currently active policy 22 remains active. The policy set includes a “null policy” that keeps the device in the highest power state to achieve the best performance. If the null policy produces the best estimate, none of the eligible power management policies can save power for the current workload. Under this condition, the power management function is disabled until the evaluator 24 is triggered again.

The evaluator 24 determines when re-evaluation should take place and performs the evaluation of eligible policies. In an illustrated embodiment, average power is used as the optimization metric at block 34. To minimize average power, the evaluator 24 requests an estimate from each policy and selects the policy with the lowest energy estimate for the device access trace. Since average power is energy consumption over time and the traces record the same amount of time, the two metrics are equivalent.

The present system and method may illustratively be implemented in a Linux 2.6.17 kernel to demonstrate HAPPI's ability to select policies at run-time, quantify performance overhead, and provide a reference for future OSPM. Functions are added to maintain policy sets and issue state change requests. Policies, evaluators, and most measurements are implemented as loadable kernel modules that may be inserted and removed at run-time as discussed herein. The only measurement that is not implemented as a loadable module is a device's access history.

The Linux kernel is optimized for performance and exploits disk idleness to perform maintenance operations such as dirty page writeback and swapping. To facilitate power management, the 2.6 kernel's laptop mode option is used, which delays dirty page writeback until the disk services a demand access or the number of dirty pages becomes too large.

Inserting and Removing Policies

The present system and method manages the different policies in the system and ensures that only one policy is active on each device at a time. FIG. 3 illustrates a timeline of actions for policy registration. The left column indicates actions taken by the policy. The right column shows actions taken by HAPPI. Arrows indicate function calls and return values. A policy registers with HAPPI before it may be selected to control devices. Registration begins when a policy is inserted into the kernel using “insmod”. A spin lock illustratively protects the policy list and is acquired before the policy can begin registering with HAPPI. The policy calls a function “happi_register_policy” to inform HAPPI that it is being inserted into the kernel and indicates the types of devices the policy can manage. HAPPI responds by returning a unique “HAPPI_ID” to identify the policy on future requests. The policy registers callback functions to begin the policy's control of a device (initialize), stop the policy's control of a device (remove), and provide an estimate to the evaluator for a device (estimate). The policy initializes local data structures for each eligible device. The policy requests notification of specific system events through the “happi_request_event” function. These events include notification after each device access or a state transition. However, these events are received by only the active policy and measurements to reduce the overhead of multiple policies running simultaneously. HAPPI filters the event request by only creating notifications for eligible devices. After the notifications have been created, the policy releases the spin lock and is eligible for selection. Since policy registration uses the “insmod” command, administrator privilege is required to add new policies. Hence, policies do not cause any security breaches.

Recording Device Accesses and State Transitions

Previous studies assume that each I/O access is a single “impulse-like” event. However, the impulse-like model of an access is insufficient to manage policies' predictions. Accesses should be defined by a time span of activity extending from the completion of an access to the completion of the last access after a filter length. In reality, an I/O access consists of two parts: a top-half and a bottom-half [29]. When it performs a read or write operation, an application uses system calls to the OS to generate requests. The OS passes these requests on to the device driver on behalf of the application. This process is called the top-half. The application may continue executing after issuing write requests but must wait for read requests to complete. The device driver constitutes the bottom-half. The bottom-half interfaces with the device, returns data to the application's memory space, and marks the application as ready to resume execution. The mechanism allows top-half actions to perform quickly by returning to execution as soon as possible.

Bottom-half tasks are deferred until a convenient time. This mechanism allows the OS to merge adjacent blocks into a single request or enforce priority among accesses. Since the bottom-half waits until a convenient time to execute, the mechanism is referred to as deferred work. Since accesses may be deferred, multiple accesses may be issued to a device consecutively. Simunic et al. [18] observe that policies predict more effectively if a 1000 ms filter is used for disk accesses and 250 ms filter is used for network accesses. These filters allow multiple deferred accesses to be merged into a single access.

Deferred work plays an important role in managing state transitions in Linux. When a state transition is requested, a command is passed to a bottom-half to update the device's power state. The actual state transition may require several seconds to complete and does not notify Linux upon completion. The exact power state of a device during a transition is unknown to Linux because the commands are handled at the device-driver level. Device accesses are managed in device drivers, as well, implying that the status of outstanding requests are also unknown and cannot be used to infer power states. HAPPI could obtain the exact power state of a device by modifying the bottom-half in the device driver. However, drivers constitute 70 percent of Linux's source code [30]. Any solution that requires modifying all device drivers is not scalable. Modifying the subset of drivers for the target machine is not portable. Hence, the present system and method estimates state transition time using ACPI information and update the state after the time expires.

Maintaining Access History

Policies require knowledge of device accesses to predict idleness and provide estimates for policy selection. The method for measuring device accesses directly affects HAPPI's ability to select the proper policy for different workloads. We describe above how a filter merges deferred accesses into a single access. When a request passes through the filter, HAPPI records the access in a circular buffer. A circular buffer illustratively is used rather than a dynamically-allocated list to reduce the time spent in memory allocation and release and limit the amount of memory consumed by HAPPI. However, other types of storage may be used. After HAPPI records the access, the active policy and all measurements are notified of the event. Since all policies require information about device accesses, these functions are statically compiled into the kernel. Access histories are the only components of HAPPI that cannot be loaded or removed at run-time.

The system and method of the present invention determines the circular buffer's length experimentally because the proper buffer length depends on workloads. FIG. 4(a) illustrates an access trace consisting of five unique workloads. Each workload is separated by a vertical line and labeled. FIG. 4(b) illustrates the amount of history (in seconds) retained by HAPPI for circular buffer sizes of 4, 8, 16, and 32 entries. When no accesses occur, the history length increases linearly. If a new access overwrites another access in the circular buffer, the history length decreases sharply. An ideal history provides full knowledge of the current workload and zero knowledge of previous workloads. The ideal history would appear as a linear slope beginning at zero for each workload. A circular buffer naturally discards history as new accesses occur. FIG. 4(c) shows how much history overlaps with previous workloads. This plot appears as a staircase function because history is discarded in discrete quantities as accesses are overwritten in the circular buffer.

The present system and method targets interactive workloads, common to desktop environments. An 8-entry buffer is illustratively used because this buffer quickly discards history when workloads change but maintains sufficient history to select policies accurately. FIG. 4(c) illustrates that the 8-entry buffer requires 107 seconds to discard Workload 2 (indicated at point A) and 380 seconds to discard Workload 3 (point B). In contrast, the 16-entry buffer requires 760 seconds to discard Workload 3 (point C) and cannot completely discard Workload 2 before Workload 3 completes. The 4-entry buffer discards history more quickly than the 8-entry buffer but does not exhibit a sufficiently long history to estimate policies' energy consumption accurately. Systems with less variant workloads, such as servers, may use a larger buffer, such as a 32-entry buffer. A larger buffer requires longer to discard past workloads but allows for a better prediction of the current workload in steady-state operation. The buffer length is set by the administrator.

Advanced Measurements

The present system and method provides an access history for each device to facilitate policy selection. However, some policies require more complex data than access history, such as request state transition probability matrices [10]. Advanced measurements can be directly computed from the history of recent accesses. Since such information is not required by all policies, HAPPI does not provide the information directly. HAPPI provides the minimum common requirements for policies. This design is based upon the end-to-end argument of system design [31] by providing the minimum common requirements to avoid unnecessary overhead. Although it does not directly provide these complex measurements, HAPPI provides an interface for measurements to be added as loadable kernel modules. A new measurement registers a callback function pointer with HAPPI that returns the measurement and requests events similar to the other policies. If a policy requires additional measurements, the policy calls the “happi_request measurement” function with an identifier for the measurement. HAPPI returns a function pointer that the policy can use to retrieve the measurement data.

The system and method of the present invention implements measurements as separate kernel modules because several policies may require the same measurement. By separating the measurement from the policies, the measurement is computed once for all the policies in the system. Since measurements are always needed, they receive all requested events, whereas inactive policies do not respond to events. If policies were individually responsible for generating measurements, their measurements would only consider the time when the policy has been active. Thus, policies would consider different time spans in their estimator functions. Implementing measurement as separate modules also allows measurements to be improved independently of policies.

Evaluating and Changing Policies

The system and method of the present invention automatically chooses the best policy for each device for the current workload and allows power policies to change at run-time, whereas existing power management implementations require a system reboot. HAPPI's evaluator is responsible for selecting the active policy. The evaluator is a loadable kernel module, allowing the system administrator to select an evaluator that optimizes for specific power management goals, for example, to minimize energy consumption under performance constraints. Since the evaluator is a loadable module, the administrator may change evaluators without rebooting if power management goals change. The administrator inserts the module using the “insmod” command. From this point onward, the evaluator selects power policies automatically. When a policy is inserted into the kernel using “insmod”, the evaluator is notified that a new policy is present and re-evaluates all policies. After the best policy is selected for each device, HAPPI enters the steady-state operation above.

If the evaluator 24 changes the active policy 22, the old policy must relinquish control of the device's power states and the new policy must acquire control. FIG. 5 illustrates how HAPPI changes policies at run-time without rebooting. The left column indicates actions taken by the old policy. The middle column describes HAPPI's actions. The right column indicates the new policy's actions. When notified by the evaluator to change the active policy, HAPPI deactivates all events for the old policy, and the policy will not receive any further system events. HAPPI disables interrupts and acquires a spin lock protecting the device. Disabling interrupts prevents any of the old policy's pending timers from expiring and blocks accesses from being issued or received from the device.

Acquiring the spin lock prevents HAPPI from interrupting the old policy if it is currently issuing a command to the device. Once the spin lock is acquired, the old policy is no longer capable of controlling the device. The old policy's remove function is called to delete any pending timers and force the policy to stop controlling the device. After the old policy has successfully stopped controlling the device, HAPPI enables the events for the new policy and calls the new policy's “initialize” function. The new policy uses this function to update any stale data structures and activate its timers. At this point, HAPPI enables interrupts and releases the device's spin lock, allowing the new policy to become active. The performance loss for disabling interrupts and acquiring locks is negligible.

Replaced policies may elect to save or discard their current predictions. If history is saved, the information may be used when selected in the future or in future estimates. In one illustrative embodiment, previous history are discarded when a policy is replaced in favor of a different policy. A policy is replaced because its estimate indicates that it is incapable of saving as much energy as another eligible policy for the current workload. Replacement implies that a policy's idleness prediction is poor. Hence, discarding previous history resets the policy's predictions to an initial value when providing another estimate and often allows the policy to revise its prediction much more quickly than by saving history.

Changing policies indicates that (a) the old policy is mispredicting or (b) the new policy can exploit additional idleness. HAPPI must evaluate policies frequently enough to detect these conditions. FIG. 6 illustrates two workloads where these conditions occur. Vertical bars indicate device accesses. FIG. 6(a) depicts a workload changing from long to short idleness. This transition is likely to induce mispredictions because policies over-predict the amount of idleness. Policies quickly correct their predictions to avoid frequent shutdowns. When the previous workload is discarded from HAPPI's access trace, a new policy is selected that predicts idleness more effectively and consumes less energy for the new workload. FIG. 6(b) depicts a workload changing from short to long idleness. Policies that make decisions on each access cannot recognize and exploit long periods of idleness because no accesses occur to update the policies' predictions. To reduce missed opportunities to save energy, the present system and method evaluates policies frequently. HAPPI evaluates all policies once every 20 seconds to determine if a better policy is eligible among the available policies. This interval is selected because it exhibits quick response to workload changes without thrashing between policies. Here, thrashing means changing policies too often, in particular, changing policies every time policies are evaluated. Shorter intervals detect changes in workload more quickly, but policies thrash when changing workloads, whereas a longer interval reduces thrashing at the cost of slower response to workload changes. We demonstrate below that a 20 second evaluation period evaluates quickly but does not significantly reduce system performance.

Performance Overhead

We use “oprofile” [32] to quantify the computational overhead for automatic policy selection. HAPPI consists of two types of overhead beyond the traditional single-policy power management approach: recording access history and policy estimation. Recording access history is unnecessary in single policy systems because the responds to accesses immediately. Estimation is required by HAPPI to determine the best policy from a policy set.

To compute the performance overhead from HAPPI, we run the benchmark described below and add the execution times of the history and estimation functions. A summary of profiling results for HAPPI's default configuration is shown in Table I. This configuration uses an 8-entry history buffer, a 20 second evaluation period, and five policies. Profiling indicates that 0.265 percent of all execution time is HAPPI overhead. Of this overhead, 0.155 percent is spent recording access history and 0.041 percent of execution time is spent evaluating policies. The cumulative execution time of all HAPPI components, including policies, policy selection, and state changes, is 0.299 percent. Hence, automatic policy selection causes little decrease in system performance, implying that it is practical for a variety of systems, including high-performance computers.

TABLE I

| | Samples | Execution Time |
|---|---|---|
| Recording Functions | 2,838 | 0.155% |
| Evaluation Functions | 760 | 0.041% |
| All Policy Functions | 624 | 0.034% |
| Other HAPPI Functions | 1,257 | 0.069% |
| Total | 5,479 | 0.299% |

FIG. 7 illustrates HAPPI's performance overhead for different configurations. FIG. 7(a) depicts HAPPI's performance as the number of policies varies from one to five. A slight increase occurs in overhead as the number of policies increase due to longer evaluation. The time required to record access history remains constant across the different numbers of policies. The two-policy configuration consists of two policies: the null policy and the nonstationary Markov model policy. The two-policy configuration indicates higher performance overhead than the other configurations because the complicated nonstationary Markov model policy is always selected. FIG. 7(b) illustrates performance as the evaluation period varies. As the evaluation period is reduced, overhead increases significantly due to the increased amount of time spent evaluating policies. However, the other overhead components remain constant. FIG. 7(c) shows performance overhead as the history buffer length varies. The evaluation time increases proportionally to the buffer length because a longer history must be considered during evaluation. Stable workloads may use a larger buffer to provide better predictions in steady-state operation. The profiling results in FIG. 7(c) indicate that the evaluation period should be increased to maintain the same overhead as a smaller buffer. This change has little effect on HAPPI's ability to select policies because stable workloads are less likely to change policies quickly.

When five policies are eligible, the total overhead is less than 0.3 percent. These results indicate that HAPPI is capable of supporting many policies with acceptable overhead. The overhead to record access history is independent of the number of policies. The evaluation function overhead is proportional to the number of policies in the system and their complexity. Since evaluation occurs infrequently (every 20 seconds), estimation's impact on performance is small. The performance overhead from policies is bounded by the complexity of the most computationally intensive policy and independent.

The system and method of the present invention allows an existing policy to be removed and a new policy to be added without rebooting the system. Hence, HAPPI can be used as a framework for iteratively improving policies. All the examples provided herein may be performed without rebooting the machine. This is important because policies may require many modifications (i.e., tuning) to achieve energy savings. Two policies, exponential averages [16] and nonstationary Markov models [10], are illustrated and iterative improvements are performed to the policies.

One illustrated example managed three devices including an IBM DeskStar 3.5″ disk (HDD), a Samsung CD-ROM drive (CD-ROM), and a Linksys NC100 PCI network card (NIC). The parameters for the devices were determined by experimental measurement using a National Instruments data acquisition card (NI-DAQ). A PCI extender card was used to measure energy consumption for the NIC.

Table II lists the information required by the ACPI specification for each device. The active state is the state where the device can serve requests. The sleep state is a reduced power state in which requests cannot be served. Changing between states incurs energy and wakeup delay shown in Table II. For reference, the break-even time is included of each device.

TABLE II

| | | HDD | | CD-ROM | | NIC | |
|---|---|---|---|---|---|---|---|
| Active | Power | 2.6 | W | 4.51 | W | 0.095 | W |
| Sleep | Power | 1.6 | W | 1.75 | W | 0.063 | W |
| | Wakeup Delay | 5.2 | s | 5.59 | s | 4.0 | s |
| | Energy | 12 | J | 159 | J | 0.325 | J |
| | Break-even Time | 12 | s | 10.5 | s | 10.2 | s |

To illustrate the present system and method's ability to track changes in workloads and selected policies, applications were executed that provide a wide range of activities for HAPPI to manage. The activity level of each device for each workload is indicated in Table III. The workloads include:

Workload 1: Web browsing+buffered media playback from CD-ROM.

Workload 2: Download video and buffered media playback from disk.

Workload 3: CVS checkout from remote repository.

Workload 4: E-mail synchronization+sequential access from CD-ROM.

Workload 5: Kernel compile.

TABLE III

| # | HDD | CD-ROM | NIC |
|---|---|---|---|
| 1 | Idle 45-75 s | Bursty | Idle 45-75 s |
| 2 | Bursty | Idle | Bursty |
| 3 | Busy | Idle | Busy |
| 4 | Periodic 60 s | Idle 70-120 s | Periodic 60 s |
| 5 | Busy | Idle | Idle |

### Access Patterns for Workloads

Accuracy of Estimator Models

Accurate power models are required by estimates to determine the correct power policies for each device. This section performs a series of experiments to indicate how accurate estimators are in practice, compared to the hardware they model. We run a sample workload on the hardware and compare the estimates at each time interval to the hardware measurements. The relative error between estimators is more important than the absolute error of individual policies because HAPPI needs only to choose the best policy from the eligible policies. We observe differences of 14 percent, 20 percent, and 13 percent between policies for the HDD, CD-ROM, and NIC, respectively. The exponential average policy exhibits a higher percent error than the other policies for the CD-ROM because the CD-ROM automatically enters a low-power mode after long periods of idleness. This state cannot be controlled or disabled by the OS. However, we note that the exponential average policy is very unlikely to be selected in these circumstances, as the other policies are able to exploit the idleness more effectively.

The accuracy of these estimators dependent upon the power model. Many papers [33]-[38] have studied power models. In HAPPI, power models may also be inserted as loadable modules. This mechanism allows power models to be improved independently of policies. Simple state-based power models are illustratively used for the estimators and determine power consumption for our devices through physical measurement. These measurements should be available through ACPI, but most I/O hardware devices do not fully implement the ACPI specification yet. The present system and method simplifies the implementation of policies and provides a motivation for hardware manufacturers to fully implement the ACPI specification.

Exponential Average Policy

The exponential average policy [16] predicts a device's idleness and makes decisions to shut down a device immediately following each access. The exponential average policy is abbreviated herein as “EXP.” This policy illustratively uses the recursive relationship I[n+1]=αiₙ+(1−α)I[n] to predict the idleness after the current access I[n+1] from the previous prediction I[n] and the previous actual idle length iₙ. The parameter α is a tunable parameter (0≦α≦1) that determines how much to weight the most recent idle length. The authors in [16] suggest α=0.5.

Accesses must pass through a filter to record deferred accesses properly as discussed above. If the policy is implemented exactly as described in [16], EXP exhibits poor performance and energy savings because the policy does not account for deferred accesses. EXP makes decisions immediately following an access, but the policy cannot ensure additional deferred accesses will not occur until the filter length has expired. The original version of EXP is referred to herein as “EXP-unfiltered.” In an illustrated embodiment of the present system, modification to EXP is delayed until the filter length has expired before making state transition requests. This modification improves the likelihood that a burst of deferred accesses is completed before shutting down a device. This new version of the policy is referred to herein as “EXP-filtered.”

The present system and method uses HAPPI to compare the two policies. FIG. 8 compares the energy estimates between the EXP-unfiltered and EXP-filtered policies. On this figure, the horizontal axis indicates time. The vertical axis represents each estimate's average power. The Gantt chart in FIG. 9 summarizes the estimates by indicating the selected policy at each evaluation interval. A cross (‘+’) indicates the selection of the policy on the vertical axis at the time indicated on the horizontal axis. Vertical bars separate workloads. FIG. 8 illustrates that the estimates spike after each access (point A) indicating that the EXP-unfiltered policy handles accesses poorly. The EXP-unfiltered policy consumes more energy than the EXP-filtered policy for the majority of its execution. EXP-filtered exploits many opportunities to save energy (points A-F). At point G, EXP-unfiltered exploits brief periods of idleness more effectively than EXP-filtered, but EXP-filtered does not waste energy. Little difference between the two policies is observed for the NIC because the bursty behavior causes both policies to mispredict frequently. The physical measurements in Table IV verify that the evaluator selects the correct policy. The EXP-unfiltered policy saves 0.2 percent, 2.8 percent, and 6.5 percent energy compared to the NULL policy for the HDD, CD-ROM, and NIC, whereas the EXP-filtered policy saves 7.2 percent, 28 percent, and 7.2 percent energy for devices, respectively. Table IV indicates the percent improvement of EXP-filtered compared to EXP-unfiltered relative to NULL.

TABLE IV

| Device | NULL | EXP-unfiltered | EXP-filtered | Improvement |
|---|---|---|---|---|
| HDD | 11,469 J | 11,451 J | 10,648 J | 7% |
| CD-ROM | 16,961 J | 16,488 J | 12,187 J | 25% |
| NIC | 417 J | 390 J | 387 J | 1% |

The illustrative embodiment of FIGS. 8 and 9 implies that decisions cannot be made immediately following an access because additional accesses may occur before the filter length has expired. This suggests a fundamental change in the way policies make decisions. Namely, all access-driven policies should include timeout policies, with timeout length equal to the filter length. The EXP policy is illustratively modified to include this filter. All future references to EXP herein for the HDD and CD-ROM include the filter. The power savings of the three policies is able to be compared because HAPPI simultaneously evaluates these policies. In fact, HAPPI's ability to select policies at run-time results in greater energy savings than any of the individual policies. Moreover, the modified policy can be implemented easily and inserted into the policy set using the HAPPI framework.

The present system and method may be used to tune various policy parameters for the target hardware. Tuning is important because it allows the policy to achieve better energy savings on each device. The main parameter of EXP is the exponential weight a. The policy in [16] suggests a=0.5. Values for a of 0.25, 0.5, and 0.75 were considered to determine the best a for each device. Table V indicates that very little difference exists between different a values. Hence, designers should not spend too much effort tuning α's value, since changes have a negligible impact on energy savings. The present system and method allows us to simultaneously compare the effects of different α values and conclude that the difference is negligible. Hence, the present system and method can help designers decide where to focus efforts for energy savings.

TABLE V

| Device | NULL | α = 0.25 | α = 0.5 | α = 0.75 | Improvement |
|---|---|---|---|---|---|
| HDD | 11,469 J | 10,758 J | 10,320 J | 10,648 J | 4% |
| CD-ROM | 16,961 J | 11,328 J | 11,240 J | 12,187 J | 6% |
| NIC | 417 J | 439 J | 405 J | 387 J | 12% |

D. Nonstationary Markovian Policy

The nonstationary Markovian policy [10] models device accesses using Markov chains. This the nonstationary Markovian policy is abbreviated herein as “NSMARKOV.” At fixed periods, called time slices, NSMARKOV computes a state transition probability matrix for the device. This matrix contains the probability that a request occurred in each power state and is implemented as a measurement in HAPPI. At each time slice, NSMARKOV uses the matrix's measurement to index into a lookup table that specifies the probability of issuing each power transition command. NSMARKOV also uses preemptive wakeup, where the device may be awakened before an access to improve performance.

1) Preemptive Wakeup: NSMARKOV described in [10] may awaken a device before an access occurs. This mechanism provides statistical guarantees for performance. The authors of [10] demonstrate similar energy savings to other policies for a laptop disk and a desktop disk. The system and method of the present invention determines if these conclusions are valid for different devices. The policy with preemptive wakeup is referred to herein as NSMARKOV-preempt and the policy without preemptive wakeup as NSMARKOV-no-preempt.

FIG. 10 illustrates the estimates and policy selections for the NSMARKOV-preempt and NSMARKOV-no-preempt policies. The large spikes in FIG. 10(a) indicate that the estimated energy consumption for NSMARKOV-preempt is significantly higher than NSMARKOV-no-preempt for all devices. FIG. 10(b) shows that the NSMARKOV-no-preempt policy is selected for all devices and workloads. Preemptive wakeup consumes more energy for the HDD and the CD-ROM.

The energy measurements in Table VI support this claim. The NSMARKOV-preempt policy consumes 40 percent and 79 percent more energy than the NSMARKOV-no-preempt policy for the HDD and CD-ROM, respectively. NSMARKOV-preempt consumes 5 percent less energy than NSMARKOV-no-preempt for the NIC. Closer inspection of the experiment reveals that NSMARKOV-preempt's performance improvements reduce overall run-time of the experiment by 6 percent. Hence, the energy consumption is lower than NSMARKOV-no-preempt. The system and method of the present invention compares policies automatically and chooses the best policy for the current workload and hardware. A system may include both preemptive and nonpreemptive policies. The system and method of the present invention selects the most effective policy based on the workload. In this example, only energy savings are compared. The evaluator 24 can also consider performance when selecting policies and may select NSMARKOV-preemptive due to its improved performance.

TABLE VI

| | | NSMARKOV- | NSMARKOV- | |
|---|---|---|---|---|
| Device | NULL | preempt | no-preempt | Improvement |
| HDD | 11,469 J | 11,235 J | 8,004 J | 10% |
| CD-ROM | 16,961 J | 15,744 J | 8,777 J | 41% |
| NIC | 417 J | 279 J | 295 J | −4% |

2) Tuning Decision Period: NSMARKOV makes decisions at periodic intervals called time slices. The time slice length is important because the length affects the expected time between device state changes. Different access patterns and power parameters may require different time slices to reduce energy consumption. The system and method of the present invention assists the process of selecting a proper time slice for each device. FIGS. 11 (a) and 11 (b) show the estimates for 1-second, 3-second, and 5-second time slices and the selected time slices for each device. Table VII indicates that the HDD saves more energy with the 3-second policy than the 1-second and 5-second policies. The system and method of the present invention confirms this result by selecting the 3-second policy most frequently. FIG. 11(b) shows that policies change rapidly during Workload 4 (point A). Since NSMARKOV employs a random number generator, the selected policy may vary during some workloads. However, the 3-second policy is still selected most often, indicating it to be the most favorable policy. All estimates increase sharply at point B. Since Workload 5 has many HDD accesses, no policy can save energy. Hence, all estimates are near the active power of the HDD.

TABLE VII

| Device | NULL | 1 second | 3 seconds | 5 seconds | Improvement |
|---|---|---|---|---|---|
| HDD | 11,469 J | 8,497 J | 7,949 J | 8,004 J | 5% |
| CD-ROM | 16,961 J | 8,952 J | 8,654 J | 8,777 J | 2% |
| NIC | 417 J | 371 J | 341 J | 295 J | 18% |

The CD-ROM selects a 3-second time slice because CD-ROM accesses tend to be bursty. Since the CD-ROM is a read-only device, it is only accessed on demand reads. The accesses cease when the application finishes reading files, creating bursty behavior. A 3-second time slice exploits this behavior by shutting down shortly after bursts. The 1-second time slice is too short and occasionally mispredicts bursts. The policy selection varies during Workload 4. In this workload, idleness varies more widely and decisions should become more conservative to avoid wasting energy. FIG. 11(a) illustrates that the difference in estimates is small, indicating that the 3-second time slice only slightly less efficient than the 5-second time slice. Table VII confirms the present system's selections by showing that the 3-second policy consumes the least energy of the three time slice lengths.

For the NIC, a 5-second time slice saves more energy because accesses are more frequent and less predictable than the other devices. Smaller time slices shut down more aggressively and mispredict frequently under the NIC's workloads. Little difference is observed between estimates because little energy penalty results from misprediction when long idleness is considered. The difference is more obvious during Workload 3 (point C) because the history length is much shorter. Shorter time slices mispredict the bursts, resulting in much higher estimates. A similar instance is observed at the start of Workload 4 (point D). Table VII validates the present system's selection, indicating that the 5-second time slice saves 18 percent and 11 percent more energy with respect to NULL than the 1-second and 3-second time slices, respectively.

Since the present system and method selects the best policy among all eligible policies, it is easy to determine the values for the policy parameters. In fact, the same policies can be loaded into HAPPI with different parameters. HAPPI selects the policy with better energy savings, hence, removing parameter tuning altogether. The policy designer need only specify a set of reasonable values and insert all the policies into HAPPI.

Selecting the Best Policies Using HAPPI

The system and method of the present invention may also be used to select the best policy for a given workload. The same evaluation mechanism discussed above is used to select the best policy from a set of distinct policies because HAPPI makes no distinction between the same policies with different parameters and completely different policies. Five power management policies are illustratively considered including the null policy (NULL), 2-competitive timeout (2-COMP) [15], adaptive timeout (ADAPT) [39], exponential averages (EXP) [16], and the nonstationary Markovian policy (NSMARKOV) [10]. In ADAPT, the policy uses the breakeven time as its initial value and changes by 10 percent of the break-even time on each access. EXP-filtered and NSMARKOV-no-preempt are used in an illustrated embodiment. Any other desired policies may also be used. However, each policy is tuned individually to improve readability of figures. The present system is capable of selecting the correct policy for different workloads. In this embodiment, distinct policies, rather than different parameters of the same policy are compared. FIG. 12(a) illustrates the policies' estimates for each workload 1-5 described above. FIG. 12(b) summarizes the estimates by indicating the policy selected at each evaluation interval.

We begin by observing the estimates for the HDD. FIG. 12(b) indicates that NSMARKOV is the most commonly selected policy for all workloads. FIG. 12(a) reveals that NSMARKOV begins saving energy very quickly after the experiment begins. NSMARKOV has the benefits of both EXP and ADAPT. At points A and B, EXP shuts down the HDD before another burst arrives. EXP's estimate rises above NULL to indicate mispredictions. The 2-COMP, ADAPT, and NSMARKOV estimates do not increase as sharply because these policies do not shut down the device before the next burst. However, 2-COMP and ADAPT require longer to shut down when idleness does exist. Since it maintains a probability matrix for accesses, NSMARKOV is likely to predict bursts correctly and more likely to shut down quickly during idleness. These characteristics are important in Linux because most disk accesses occur in bursts, due to dirty page writeback and file read-ahead. NSMARKOV's ability to handle bursts effectively allow the policy to save more energy than other policies during Workload 4, indicated by span C. In this workload, accesses occur with widely varying intervals. The 2-COMP policy consumes the most energy because it requires much longer to shutdown than the other policies and often waits too long to shut down the device. Table VIII shows that the present system's choice is the correct policy. NSMARKOV consumes 6 percent less energy than 2-COMP, 11 percent less than ADAPT, and 24 percent less than EXP with respect to NULL.

TABLE VIII

| Device | NULL | 2-COMP | ADAPT | EXP | NSMARKOV | Energy Savings |
|---|---|---|---|---|---|---|
| HDD | 11,469 J | 8,666 J | 9,213 J | 10,320 J | 7,949 J | 23% |
| CD-ROM | 16,961 J | 10,685 J | 12,663 J | 11,240 J | 8,654 J | 24% |
| NIC | 417 J | 362 J | 386 J | 387 J | 295 J | 22% |

The CD-ROM exhibits a very different workload from the HDD. It was determined above that a 3-second time slice saves more energy than longer periods because CD-ROM accesses are very bursty. The beginning of Workload 1 exhibits this behavior and is indicated at point D in FIG. 12 (a) by a high EXP estimate and a low NSMARKOV estimate. At point E, several accesses occur to read a new audio track. NSMARKOV mispredicts on these accesses due to the prior idleness, and the selected policy briefly changes to EXP. After the burst completes, NSMARKOV is selected again. At points F and G, it is observed that EXP mispredicts bursts and is unable to save as much energy as the other policies. The CD-ROM is idle during span H. EXP's estimate increases because the policy mispredicts the last access and does not shut down the CD-ROM during span H. All other estimates improve because they predict the last access correctly. However, the energy estimates are different in magnitude because the policies shut down the CD-ROM after different amounts of time. During Workload 4, more bursty accesses occur. NSMARKOV is selected to exploit idleness immediately following the bursts. Table VIII verifies that the present system has chosen the correct policy.

The NIC experiences bursty accesses, as well. However, the NIC's accesses are often followed by more bursty accesses during spans K and L. As described above, NSMARKOV predicts these accesses well using a 5-second time slice. EXP, ADAPT, and 2-COMP mispredict frequently, as indicated by sharp spikes in their estimates. NSMARKOV uses statistical information about the workload to become more conservative in its shutdowns. Table VIII indicates that HAPPI selects the proper policy.

This illustrated embodiment compares several distinct policies simultaneously on different devices and provides insight into policies' properties that make them effective in commodity OSs. Several opportunities exist to save energy for the HDD. However, the workloads frequently change before some policies can adapt to the new workloads. Two properties of the HDD access trace indicate that ADAPT and EXP policies are unlikely to achieve significant energy savings beyond NSMARKOV. First, accesses do not arrive quickly enough to adapt to idle workloads because Linux's 1 apt op_node clusters accesses together. Second, when accesses arrive quickly, insufficient idleness exists to save significant energy. Hence, ADAPT and EXP are unlikely to save more energy than NSMARKOV for HDD workloads.

In contrast, for the CD-ROM and NIC, accesses arrive in bursts for both devices and allow many opportunities to save energy if bursts can be predicted accurately. However, we observe that NSMARKOV's probabilistic models detect bursts more accurately than ADAPT and EXP, which are heavily weighted by recent history. In the illustrated embodiment, NSMARKOV is the best policy among the five eligible policies. The present system allows experiments to be performed easily, even for advanced policies.

Even though only five policies are illustrated herein, it is understood that many new policies may be added due to HAPPI's low overhead. Users may perform experiments with their innovative policies on real machines easily. The simple interface of the present invention encourages the development of sophisticated policies that can save more energy.

The illustrated embodiment considers policies that control devices independently. Many policies [7], [24]-[28] have been designed to control multiple devices simultaneously. The present system and method provides a mechanism that may be adapted to choose between multiple independent policies or a single policy that controls multiple devices.

Many policies rely on application-directed power management [40]-[42]. Application programs issue power commands intelligently based on applications' future access patterns. Although we have a different goal than application-directed power management, HAPPI does not preclude the use of application-directed power management. Policies for application-directed power management can be implemented as kernel modules and export interfaces to applications. These policies provide estimates to HAPPI to determine if application-level adaptation can provide more energy savings than other policies in the system. No studies consider a mix of adaptive and nonadaptive applications. HAPPI provides a mechanism to compare application-directed policies and allows comparison of application-directed policies with unmodified applications.

Source code for HAPPI and the policies included herein are available for download at http://engineering.purdue.edu/AOSEM.

The system and method of the present invention provide an improved architecture that allows policies to be compared and selected automatically at run-time. Policy configurations are heavily dependent on a device's power parameters and workload. Therefore, policies should be tuned for specific platforms for best performance. The system and method of the present invention simplifies this configuration process by automatically selecting the proper policy for each device.

Workload Adaptation with Energy Accounting in a Multi-Process Environment

The following listed references are expressly incorporated by reference herein. Throughout the specification, these references are referred to by citing to the numbers in the brackets [#].
[1A] L. Benini and G. D. Micheli. System-Level Power Optimization: Techniques and Tools. ACM Transactions on Design Automation of Electronic Systems, 5(2):115-192, April 2000.
[2A] L. Cai and Y.-H. Lu. Dynamic Power Management Using Data Buffers. In Design Automation and Test in Europe, pages 526-531, 2004.
[3A] F. Chang, K. Farkas, and P. Ranganathan. Energy-Driven Statistical Profiling Detecting Software Hotspots. In Workshop on Power-Aware Computer Systems, 2002.
[4A] E.-Y. Chung, L. Benini, and G. D. Micheli. Dynamic Power Management Using Adaptive Learning Tree. In International Conference on Computer-aided Design, pages 274-279, 1999.
[5A] V. Delaluz, M. Kandemir, N. Vijaykrishnan, A. Sivasubramaniam, and M. J. Irwin. Hardware and Software Techniques for Controlling DRAM Power Modes. IEEE Transactions on Computers, 50(11):1154-1173, November 2001.
[6A] J. Flinn and M. Satyanarayanan. Energy-Aware Adaptation for Mobile Applications. In ACM Symposium on Operating Systems Principles, pages 48-63, 1999.
[7A] J. Flinn and M. Satyanarayanan. PowerScope: A Tool for Profiling the Energy Usage of Mobile Applications. In IEEE Workshop on Mobile Computing Systems and Applications, pages 2-10, 1999.
[8A] C. Gniady, Y. C. Hu, and Y.-H. Lu. Program Counter Based Techniques for Dynamic Power Management. In International Symposium on High Performance Computer Architecture, pages 24-35, 2004.
[9A] C.-H. Hwang and A. C.-H. Wu. A Predictive System Shutdown Method for Energy Saving of Event-driven Computation. ACM Transactions on Design Automation of Electronic Systems, 5(2):226-241, April 2000.
[10A] A. Karlin, M. Manasse, L. McGeoch, and S. Owicki. Competitive Randomized Algorithms for Nonuniform Problems. Algorithmica, 11(6):542-571, June 1994.
[11A] K. Li, R. Kumpf, P. Horton, and T. E. Anderson. A Quantitative Analysis of Disk Drive Power Management in Portable Computers. In USENIX Winter Conference, pages 279-291, 1994.
[12A] Y.-H. Lu, L. Benini, and G. D. Micheli. Low-Power Task Scheduling for Multiple Devices. In International Workshop on Hardware/Software Codesign, pages 39-43, 2000.
[13A] Y.-H. Lu, L. Benini, and G. D. Micheli. Power-Aware Operating Systems for Interactive Systems. IEEE Transactions on Very Large Scale Integration Systems, 10(2): 119-134, April 2002.
[14A] R. Neugebauer and D. McAuley. Energy is Just Another Resource: Energy Accounting and Energy Pricing in the Nemesis OS. In Workshop on Hot Topics in Operating Systems, pages 59-64, 2001.
[15A] Q. Qiu and M. Pedram. Dynamic Power Management Based on Continuous-time Markov Decision Processes. In Design Automation Conference, pages 555-561, 1999.
[16A] P. Rong and M. Pedram. Hierarchical Power Management with Application to Scheduling. In International Symposium on Low Power Electronics and Design, pages 269-274, 2005.
[17A] T. Simunic, L. Benini, P. Glynn, and G. D. Micheli. Dynamic Power Management for Portable Systems. In International Conference on Mobile Computing and Networking, pages 11-19, 2000.
[18A] A. Weissel, B. Beutel, and F. Bellosa. Cooperative 10—A Novel 10 Semantics for Energy-Aware Applications. In Operating Systems Design and Implementation, pages 117-129, 2002.
[19A] C. Xian and Y.-H. Lu. Energy Reduction by Workload Adaptation in a Multi-Process Environment. In Design, Automation, and Test in Europe, pages 514-519, 2006.
[20A] H. Zeng, C. S. Ellis, A. R. Lebeck, and A. Vandat. ECOSystem: Managing Energy As A First Class Operating System Resource. In International Conference on Architectural Support for Programming Languages and Operating Systems, pages 123-132, 2002.

Further details of an illustrated embodiment of the present invention related to energy accounting in both runtime policy selection systems and workload adaptation systems are included in Exhibit C of U.S. Provisional Application Ser. No. 60/779,248, filed Mar. 3, 2006, which is expressly incorporated by reference herein entitled, “Power Management with Energy Accounting in a Multi-Process Environment”. In addition, References [1]-[32] listed in Exhibit C of U.S. Provisional Application Ser. No. 60/779,248 are all expressly incorporated by reference herein.

Dynamic power management (DPM) has been extensively studied in recent years. One approach for DPM is to adjust workloads, such as rescheduling or removing requests, as a way to trade-off energy consumption and quality of services. Since adjusting workloads often requires understanding the internal context and mechanisms of applications, some studies allow applications themselves, instead of operating system (OS), to perform the adjustment. These studies focus on a single application or process. However, when multiple concurrent processes share the same hardware component, adjusting one process may not save energy. In another embodiment of the present invention, a system and method is provided that instruments OS to provide across-process information to individual processes for better workload adjustment. The present system performs “energy accounting” in the OS to analyze how different processes share energy consumption and assign energy responsibility to individual processes based on how they affect power management. The assignment is used to guide individual processes to adjust workloads. The illustrated method is implemented in Linux for evaluation. The examples show that: (a) Our energy accountant can accurately estimate the potential amounts of energy savings for workload adjustment. (b) Guided by our energy accountant, workload adjustment by applications can achieve better energy savings and efficiency.

Many techniques [1A] have been proposed in the last several years to reduce energy consumption in computer systems. Among these techniques, dynamic power management (DPM) has been widely studied. DPM saves energy by shutting down hardware components when they are idle. Since shutting down and waking up a component consume energy, only long idle periods can justify such overhead and obtain energy savings. Most studies on DPM focus on improving power management policies to predict the lengths of future idle periods more accurately [4A], [8A], [9A], [11A], [15A], [17A]. Even though improving the power manager can effectively reduce the energy during long idle periods, a workload without long idle periods provides no opportunity for the power manager to save energy. To resolve this, the workload needs to be adjusted to create long idle periods. The studies in the literature present two types of workload adjustment: (a) clustering (also called “rescheduling”) programs' requests [2A], [12A], [16A], [18A] and (b) removing requests [6A], [7A], [20A] to tradeoff quality of service for energy savings.

In terms of what performs the workload adjustment, these studies can be classified into two approaches: (a) centralized adjustment by operating system (OS) and (b) individual adjustments by applications themselves. In the first approach, applications inform OS of the release time and the deadline of each request and OS reschedules the requests based on their time constraints [12A], [13A]. This approach can handle multiple concurrent processes. However, OS has limited understanding of the internal context and mechanisms of applications and it is often more effective to allow applications themselves to perform the adjustment. For one example, a video streaming application can lower its resolution and request fewer data from the server so the workload on the network card is reduced. For another example, a data-processing program may prefetch needed data based on the program's internal context to cluster the reading requests to the storage device. Previous studies [2A], [6A], [7A] have demonstrated the effectiveness of workload adjustment by applications for both clustering and removal (also called “reduction”).

The limitation of application-performed adjustment is that previous studies focus on a single application or process. In a multi-process environment, energy reduction may be affected by all concurrent processes. FIG. 13 (a) shows the power consumption of a hardware component that is accessed by the requests from processes 1 and 2. We use rᵢ to denote the requests from process i. The black bars in FIGS. 13 (a)-(c) represent the requests and the gray regions represent the idle periods. In FIG. 13 (b), process 2's requests are clustered (e.g., through prefetching). If clustering these requests creates sufficiently long idle periods, the component can be shut down to save energy. However, the original requests from the two processes interleave and process 1's requests are kept after process 2's requests are clustered. Suppose process 1's requests have real-time constraints and cannot be clustered. Consequently, the idle periods may be still too short to save energy. Moreover, clustering uses memory buffer. Since unused memory banks can be put into a lowpower state [5A], using memory for buffering may increase power consumption.

In FIG. 13 (c), process 2's requests are removed to reduce energy consumption. Similarly, energy may not be saved because of the requests from process 1. Without energy savings, the energy efficiency is actually lower because process 2's requests are not served. Energy efficiency is defined as the ratio of the amount of work to the energy consumption. These examples suggest that the interactions among multiple processes should be considered for energy reduction. In a multiprocess system, one process has no knowledge about other processes. To consider the interaction among multiple processes, one direction is that the processes provide information to OS and OS performs centralized adjustment [13A], [20A]. The limitation of centralized workload adjustment by OS has been explained earlier.

In the system and method of the present invention, the OS provides information to individual processes such that each process can consider other concurrent processes for better workload adjustment.

The present system and method (1) determines how much energy can be saved by adjusting an individual process in a multi-process environment (2) and then determines how such information be used at runtime to improve workload adjustment by the individual process for better energy savings and efficiency. The system uses energy accounting by OS to analyze energy sharing among multiple processes and the opportunities for energy savings. Energy accounting is performed by OS because the OS can observe the requests from multiple processes. OS also determines when to shut down hardware components to exploit the idleness between requests. The present system and method analyzes how different processes share the energy consumption of the hardware components and estimate the potential energy reduction by adjusting individual processes.

Examples are presented on workload clustering and reduction, respectively. These examples show illustrated embodiments of how to provide the accounting information to individual processes at runtime to guide their workload adjustments. For example, if clustering the requests of the current process can save little energy, the clustering can be stopped to save the energy consumed by buffer memory [2A]. The present system and method accurately reports the potential amounts of energy savings for clustering and removing requests. The method illustrated guides runtime workload adjustment to save more energy and achieve better energy efficiency.

Previous studies have considered adjusting workloads for power management. One approach is centralized adjustment by OS. Lu et al. [12A] order and cluster the tasks for multiple devices to create long idle periods for power management. Weissel et al. [18A] propose to assign timeouts to file operations so they can be clustered within the time constraints. Rong et al. [16A] divide power management into system and component levels and propose clustering requests by modeling them as stochastic processes. Zeng et al. [20A] assign an energy budget to each process and the process is suspended when its budget is consumed. Another approach is application-performed adjustment. Cai et al. [2A] use buffers to cluster accesses to a device for data streaming applications. Flinn et al. [6A] reduce the quality of service, such as the frame size and the resolution for multimedia applications, when battery energy is scarce. These studies consider only a single application or process. The system and method of the present invention considers multiple processes and instruments OS to provide across-process information to individual processes for better energy savings and efficiency.

There have been several studies profiling processes' energy responsibilities. PowerScope [7A] uses a multimeter to measure the whole computer's power consumption and correlates the measurements to programs by sampling the program counter. Their study provides information about procedural level energy consumption. Chang et al. [3A] conduct a similar measurement with a special hardware called Energy Counter. Energy Counter reports when a predefined amount of energy is consumed. ECOSystem [20A] models the energy consumption of different components individually and assigns energy to the processes by monitoring their usage of individual components. ECOSystem controls processes' energy consumption using operating system (OS) resource allocation. Neugebauer et al. [14A] perform similar energy assignment in a system called Nemesis OS providing quality of service guarantees. None of these studies examine the relationship between processes' energy responsibilities and the potential energy savings by adjusting the processes' requests. Moreover, they do not examine energy sharing in a multi-process environment and the effects of workload adjustment. Hence, these studies are insufficient for estimating the energy savings of workload adaptation in a multi-process environment.

The system and method of the present invention (a) estimates the energy savings from workload adjustment when concurrent processes are considered, and (b) provides runtime adaptation method to use the estimation to guide workload adjustment.

Energy Accounting

The present system and method uses energy accounting to integrate the power management by OS and the workload adjustment by applications in a multi-process system 100, as shown in FIG. 14. The system's three layers, Applications, OS, and Hardware, are separated by the dashed lines. The arrows show the information flows among different entities in the three layers. This system allows collaboration between user processes and OS for energy reduction. Each individual process 102 adjusts its own requests (as explained below) while the power manager 104 in OS determines when to shut down the hardware component 106 to save energy. Energy accounting is performed in an entity called Energy Accountant 108 in the OS kernel. Energy Accountant 108 monitors the requests from different processes 102 and analyzes how they share the energy consumption of hardware components 106 and estimate the potential energy savings by adjusting individual processes. The processes query such accounting information by calling the APIs provided by Energy Accountant 108 to determine when and how to adjust workload.

In the energy accounting analysis, it is first assumed that there are three power states: busy (serving requests from processes), sleeping (requests have to wait for the component to wake up), and idle (not serving requests but ready to serve without delay). The component consumes power in busy and idle states and consumes no power in the sleeping state. Power management intends to reduce unnecessary power consumption during idleness. The component wakes up if it changes from the sleeping state to the busy or the idle state. The component is shut down if it enters the sleeping state. The component's break-even time (t_{be}) is defined as the minimum duration of an idle period during which shutting down the component can save energy; namely, the energy saved in the sleeping state can compensate the switching energy for shutdown and wakeup [1A].

Energy Responsibility and Sharing

Energy responsibility is divided between the power manager 104 and the user processes so the processes' energy assignments are independent of specific power management policies. Energy responsibility is then divided among the processes based on how they affect the effectiveness of dynamic power management. The assignments are used to estimate potential energy savings from changing the workload.

Energy consumption that can be reduced by improving the shutdown accuracy is assigned to the power manager 104 and the remaining energy is assigned to the user processes. The energy assigned to a process can be reduced by adjusting the process. For example, if a hardware component serves only a single request as shown in FIG. 15 (a), the necessary energy consumption includes the wakeup energy (e_{w}), service energy (eₐ), and the shutdown energy (e_{d}).

Any additional energy can be reduced by performing wakeup and shutdown immediately before and after the service. The energy e_{w,}+eₐ+e_{d} is assigned to the process because this energy can be reduced only by removing the request. When multiple requests access a component, the necessary energy consumption is calculated based on the component's break-even time. The break-even time (t_{be}) is the minimum duration of an idle period during which the energy saved in the sleeping state can compensate the state-change energy (e_{d}+e_{w}) [1A]. If the idle period is longer than t_{be} as shown in FIG. 15 (b), the processes are responsible for only e_{d}+eₐ, in the idle period. If the idle period is shorter than t_{be} as shown in FIG. 15 (c), the energy in the idle period cannot be reduced by shutdown and such idle energy is assigned to the processes.

Symbols used herein illustratively have the meaning and units shown in Table I.

TABLE I
SYMBOLS AND MEANINGS

| Symbol | Section | Meaning | Unit |
|---|---|---|---|
| rᵢ | I | The request from process i. | |
| e_{w} | III-B | Energy for waking up a component | J |
| e_{d} | III-B | Energy for shutting down a component. | J |
| eₐ | III-B | Energy for serving a request. | J |
| eₗ | III-B | Energy for keeping a component in the | J |
| | | idle state during an idle period | |
| | | (eₗ = pₗ × tₗ). | |
| pₐ | III-B | Component's power in the busy (or active) | W |
| | | state. | |
| pₛ | III-B | Component's power in the sleeping state. | W |
| pₗ | III-B | Component's power in the idle state. | W |
| tₗ | III-B | Duration of an idle period. | s |
| t_{w} | III-B | Backward sharing period. | s |
| t_{d} | III-B | Forward sharing period. | s |
| tₐ | III-B | Period of serving a request. | s |
| Sᵣ | III-C | Potential energy savings by removing a | J |
| | | process' requests. | |
| S_{c} | III-C | Potential energy savings by clustering a | J |
| | | process' requests. | |
| Sᵤ | III-C | Current energy savings, namely, the energy | J |
| | | savings that have been obtained. | |

When a component is used by multiple processes, these processes may share the responsibility of energy consumption. The following example illustrates energy sharing among processes.

Example: Two processes use the same component, shown as r₁ and r₂ in FIG. 4. Suppose e_{w,}=2 J, e_{d}=1 J, eₐ=1 J, and pᵢ=1 W. The component's break-even time is t_{be}=(e_{w,}+e_{d})/pᵢ=3 s. The idle period between the two requests is 2.5 seconds. The energy consumed in the idle period is eₗ=pₜ×2.5=2.5 J. The total energy consumption is e_{w,}+eₐ+eₗ+eₐ+e_{d}=7.5 J. The power manager is not responsible for any energy consumption because the idle period is shorter than tbₑ. All the energy consumption (7.5 J) is assigned to the two processes. Suppose we remove process 1, the necessary energy consumption for process 2 is e_{w}+eₐ+e_{d}=4 J. The energy is reduced by 7.5−4=3.5 J. This suggests that the 3.5 J of energy is incurred by process 1. Similarly, if we remove process 2 instead of process 1, the reduced energy is also 3.5 J. If each process is responsible for only 3.5 J, the two processes are responsible for 7 J in total. There is still 0.5 J remaining. If we remove both processes, all 7.5 J can be reduced. This suggests that the extra 0.5 J is incurred by the combination of the two processes. Hence, the two processes share the extra 0.5 J.

To calculate energy sharing, we extend the concept from FIG. 3 (a). The process is responsible for energy e_{w,} before a request and e_{d} after the request. The energy corresponds to time t_{w,} and t_{d} as shown in FIG. 5 (a); they are called the backward sharing period and the forward sharing period, respectively. Their values are defined as:

$${\int }_{0}^{{t}_{w}} ρ ( t ) ⅆ t = {e}_{w} and {\int }_{0}^{{t}_{d}} ρ ( t ) ⅆ t = {e}_{d}$$

where ρ(t) is the power at time t. The value of t_{w},is calculated backward from the service, i.e., at the moment of the service, t=0. In FIG. 5 (b), t_{w},and t_{d} are the component's wakeup delay (′t_{w},) and shutdown delay (t_{d}), respectively. In FIG. 5 (c), ρ(t)=ρₗ for calculating t_{d,1} and t_{w,2}, so t_{d,1}=e_{d}/p₁ and t_{w,2}=e_{w}/pl.

Two processes do not share energy if their t_{w} and t_{d} do not overlap, as shown in FIG. 5 (b). When the idleness between the two requests becomes shorter as shown in FIG. 5 (c), t_{d,1} and t_{w,2} overlap and the two processes share energy responsibility. The energy during t_{d,1} is e_{d} and the energy during t_{w,2} is e_{w}. The energy consumption in the overlapped period is eₒ. If r₁ is removed and no longer responsible for any energy, eₒ cannot be reduced by any power manager because r₂ needs e_{w} to wake up the component and e_{w} includes eₒ. Similarly, removing r₂ cannot reduce eₒ because r₁ needs e_{d} to shut down the component and e_{d} also includes eₒ. To reduce the shared energy eₒ, both requests have to be removed. Therefore, both processes are responsible for the overlapped energy eₒ. As the idle period becomes even shorter, t_{w,2} can overlap with t_{a,1} and even t_{w,1} as shown in FIG. 5 (d). The rationale of energy sharing is the same—the energy in the overlapped period can be reduced only by removing both processes.

This approach can be extended to three or more processes by calculating their sharing periods. If their periods overlap, they equally share the energy during the overlapped interval. This method can be applied to handle the situation when multiple processes use the same component at the same time. For example, a full-duplex network card can transmit and receive packets for different processes simultaneously. From the OSs' viewpoint, the service time (tₐ) of these processes overlaps. The energy assigned to these processes is calculated using the overlap of the service time together with the forward and backward sharing periods.

Estimation of Energy Reduction

As explained herein, the shared energy cannot be reduced by removing the requests from only one of the sharing processes. Let Eₚ be the total responsible energy of a process and Eₕ be the portion of the process' responsible energy shared with other processes. Then the potential energy savings from removing the process' requests are Sᵣ=Eₚ−Eₕ.

Clustering obtains the maximum energy savings when the process' requests are all clustered together because this can create the longest idle period. This is equivalent to two steps removing the process' requests first and then adding the cluster of the requests back. Consequently, the cluster's energy consumption can be subtracted from Sᵣ to obtain the potential energy savings (S_{c}) from clustering the process' requests. Let Eₐ denote the sum of all requests' eₐ in the cluster, the energy consumption of the cluster is e_{w}+Eₐ+e_{d} and S_{c}=Sᵣ−(e_{w}+Eₐ+e_{d}).

The potential energy savings indicate the possible energy reduction by future workload adjustment. The current energy savings Sᵤ, namely, the energy savings that have been obtained is then calculated. This is used at runtime to determine whether the workload adjustment that has been performed is beneficial as further explained below. Sᵤ is equal to the total reducible energy by perfect power management excluding the responsible energy of the actual power manager. The idle period between the two requests in FIG. 17 (b) is used as an example. Since the idle period is longer than break-even time, the perfect power management should consume only energy e_{d}+e_{w} and the total reducible energy is pₗ×tₗ−(e_{d}+e_{w}). Since the responsible energy of the actual power manager in this idle period is 0, so the current energy savings is Sᵤ=pₗ×tₗ−(e_{d}+e_{w})

Effect of Expedition

The above analysis assumes that adjusting one process' requests does not affect the serving times of other processes' requests. This assumption should be reexamined because the completion time of the remaining processes may be expedited when a process' requests are removed or clustered. This is illustrated in FIG. 18 (a)-(d). In FIG. 18 (a), request r₁ is immediately followed by request r₂. It is possible that r₂ actually arrives as early as r₁ but is delayed due to r₁'s service. Without r₁, r₂ may be served earlier. This side effect of removing r₁ is referred to as “expedition”. FIG. 18 (a) also shows another request r₃ being served later than r₂ and there is an idle period between r₂ and r₃. We assume that r₃ arrives later than both r₁ and r₂ so r₃'s serving time is not affected by removing r₁. FIG. 18 (b) shows that the expedition of r₂ results in additional energy consumption in idleness. In the figure, the dashed interval represents the removed request r₁. Request r₂ originally shares the energy in t_{d,2} with r₃. There is no other requests earlier than r₂. If r₂ moves to the original location of r₁, all the periods of r₂ shift earlier by t_{a,1} and the decreased sharing between r₂ and r₃ can be at most t_{a,1}. Consequently, the expedition results in extra energy consumption of at most e_{a,1}.

On the other hand, FIG. 18 (c) shows that expedition can also lead to additional energy savings. In this case, request r₃ arrives earlier than r₂ and no request arrives after r₂. FIG. 18 (d) shows that r₁ is removed. If r₂ moves earlier by t_{a,1}, all of r₂'s periods move earlier by t_{a,1}. The sharing between r₂'s periods and r₃'s periods can increase by at most t_{a,1}. As a result, the expedition leads to extra energy reduction of at most e_{a,1}.

Combining the two cases, the additional energy savings due to expedition is within the range [−e_{a,1}, e_{a,1}]. If process 1 has multiple requests that are immediately followed by other processes' requests, we use E′ₐ to denote the total service energy of such requests of process 1. The total additional energy savings due to expedition after removing process 1 are then within the range [−E′ₐ, E′ₐ].

Multiple Sleeping States

The energy accounting rules may be extended to consider multiple sleeping states. A component cannot serve requests in any sleeping state and encounters switching delay and energy for entering a sleeping state and returning to the active state. Multiple sleeping states provide more energy saving opportunities than a single sleeping state. If another sleeping state is available with a shorter break-even time, the component can be shut down to save energy for a short idle period. We use s₁, s₂, . . . , sₙ as the n sleeping states. Without loss of generality, we assume that these states are ordered by decreasing power consumption. The component consumes the most power in s, and the least power in sₙ. State sⱼ is a deeper sleeping state than sᵢ if 1≦i≦j≦n. A deeper sleeping state has larger wakeup and shutdown energy; otherwise, the shallower sleeping states should not be used. The terms e_{w,si}, e_{d,si}, T_{w,si}, and T_{d,si} are used to denote sᵢ's wakeup energy, shutdown energy, wakeup delay, and shutdown delay, respectively.

With multiple sleeping states, the power manager's responsibility cannot be determined by simply comparing the length of an idle period with the component's break-even time. The component has multiple break-even times, one for each sleeping state. FIG. 19 shows that two processes access the component and the component is idle between the requests. The present system and method determines (a) whether the component should sleep and (b) which sleeping state to use. To determine whether the component should sleep, the length of the idle period is compared with each break-even time. If the idle interval is longer than at least one break-even time, the component should sleep. To choose a sleeping state, the system and method of the present invention determines which state can save more energy. If the idle time is longer than both s₁'s and s₂'s break-even times, entering either state can save energy. If the idle time is only slightly longer than s₂'s break-even time, entering s₂ only “breaks even”. Entering s₁ may actually save more energy.

The minimum length of an idle period when entering s₂ saves more energy. Let t be the length of an idle period. Using the two states achieves the same energy savings if

$${e}_{d , {s}_{1}} + {e}_{w , {s}_{1}} + {p}_{{s}_{1}} ( t - {τ}_{d , {s}_{1}} - {τ}_{w , {s}_{1}} ) = {e}_{d , {s}_{2}} + {e}_{w , {s}_{2}} + {p}_{{s}_{2}} ( t - {τ}_{d , {s}_{2}} - {τ}_{w , {s}_{2}} )$$

$$or$$

$$t = \frac{{e}_{d , {s}_{2}} + {e}_{w , {s}_{2}} - {e}_{d , {s}_{1}} - {e}_{w , {s}_{1}} + {p}_{{s}_{1}} ( {τ}_{d , {s}_{1}} + {τ}_{w , {s}_{1}} ) - {p}_{{s}_{2}} ( {τ}_{d , {s}_{2}} + {τ}_{w , {s}_{2}} )}{{p}_{{s}_{1}} - {p}_{{s}_{2}}}$$

This is the minimum duration of an idle period to use s₂. Notice that this threshold time is different from s₂'s break-even time because t_{be} is defined between a sleeping state and the idle state, not between two sleeping states. Similarly, when there are more than two sleeping states, such a threshold time can be calculated for every sleeping state sᵢ (i≧2) by comparing its energy consumption with all the other sleeping states. Let tᵢ be the threshold time for state sᵢ, then the component should enter the sleeping state sᵢ if the length of the idle period is within the range [tᵢ, tᵢ₊₁]

If there is only a single request, the component should be kept in the deepest sleeping state before and after serving the request in order to consume the minimum energy. Based on this principle, we use e_{w} and e_{d} of the deepest sleeping state to calculate the sharing periods t_{w} and t_{d} for each request to calculate energy sharing. Then, the same procedure described above is used to estimate energy reduction.

Workload Adaptation

As discussed above, after assigning each process its energy responsibility, the potential energy savings may be estimated by adjusting the process. Request removal and clustering for adaptation is first considered. Energy accounting can be performed at runtime such that the process can perform runtime adaptation by either requests removal or clustering for better energy savings and efficiency. Specifically, energy responsibility is periodically calculated and assigned to each process and the process is informed of the estimated energy savings S_{c} or Sᵣ. The estimation from the previous period is assumed to be usable for the following period. This assumption is adopted by many adaptation methods. We focus on how one process should adjust its workload in a multi-process environment and assume the other processes are not allowed to adjust their workloads simultaneously.

1) Requests Removal: We consider a method that allows a process to suspend for a period of time such that its requests are “removed” from the period. For example, when battery energy is scarce, a low-priority program may save its current progress and suspend as a tradeoff for energy savings. The program resumes later when energy becomes plentiful (e.g., by recharging the battery).

FIG. 20 illustrates how to use accounting information to guide requests removal. Processes P₁ and P₂ generate requests for the same hardware component (e.g., a network card). The first two rows in FIG. 20 show the original requests of the two processes without adjustment. The duration of time is divided into t₁, t₂, and t₃ by vertical dashed lines in the figure. During t₁ and t₃, only P₂ is running. During t₂, P₁ is running concurrently with P₂. We assume P₁ does not allow removal. When only P₂ is running, removing P₂'s requests can create long idle periods. When P₁ is also running, removing P₂ cannot create long idle periods because P₁'s requests are scattered.

The third and fourth rows in FIG. 20 show a method that suspends P₂ for the whole duration. This saves energy for t₁ and t₃ but not for t₂. If P₂ resumes during t₂, the energy of the scattered idleness can be utilized to serve more requests. This is achieved in our method, as shown in the fifth and sixth rows in FIG. 20. Runtime adaptation is performed using the accounting information, the potential energy savings Sᵣ and the current energy savings Sᵤ, as defined above. When Sᵣ>0, we suspend the process to save energy. If the process is being suspended and Sᵤ=0, the process is resumed to serve more requests. The six arrows represent six decision points during t₁, t₂, and t₃. At the first arrow, only P₂ is running and Sᵣ>0, so P₂ suspends. At the second arrow, energy savings is observed and Sᵤ>0, so P₂ keeps suspending. After entering t₂, P₁ starts running and Sᵤ=0. Process P₂ then resumes at the third arrow to utilize idle energy. At the fourth arrow, Sᵣ=0 because removing P₂'s requests does not save energy. P₂ thus keeps running. After entering t₃, P₁ terminates and Sᵣ>0, so P₂ suspends again at the fifth arrow. At the six arrow, Sᵤ>0 so P₂ keep suspending. Compared to suspending the process for the whole duration, this method saves the same amount of energy and serves more requests. Hence, the energy efficiency is improved.

2) Requests Clustering: We consider the method that uses a buffer to clustering the requests to a hardware component. For example, a video streaming program allocates additional memory to prefetch more frames from the server and the network card is used to fetch frames only when the buffered frames have been consumed.

FIG. 21 illustrates how to use accounting information to guide requests clustering. The original requests from processes P₁ and P₂ are the same as the first two rows in FIG. 20. There is no clustering in the original requests. This case consumes no extra buffer power but misses the opportunity to save energy in t₁ and t₃ by clustering P₂'s requests. The first and second rows in FIG. 21 show a method that clusters P₂'s requests using a buffer throughout the whole duration. Even though energy is saved for the component during t₁ and t₃, it does not save energy during t₂ while additional energy is consumed for the buffer memory. Alternatively, P₂ can perform adaptive clustering with the accounting information, as shown in the third and fourth rows in FIG. 21. The accounting information used includes the potential energy savings S_{c}, and the current energy savings Sᵤ, as defined above. The value of S_{c}, suggests whether it is beneficial to further cluster the requests but does not indicate whether the current clustering saves energy. In contrast, Sᵤ indicates how much energy savings we have obtained but does not suggests the potential of further clustering. Consequently, if S_{c}, is large, P₂ should cluster regardless of the value of Sᵤ. If the buffer has been allocated and both S_{c}, and Sᵤ are small, P₂ should stop clustering and release the buffer. This is because the small Sᵤ suggests that the current clustering is not beneficial and the small S_{c}, suggests no potential for allocating more buffer space for further clustering. After the buffer is released, the unused memory banks can enter low-power state.

The six vertical arrows in FIG. 21 represent six adaptation points during t₁, t₂, and t₃. At the first arrow, only P₂ is running and its requests are scattered. The potential savings S_{c} is large. Quantitatively, “large” or “small” means larger than or smaller than the per-period energy consumption of the buffer memory allocated for clustering. The buffer size is determined below. Since clustering is beneficial at the first arrow, P₂ allocates a buffer to cluster its requests. At the second arrow, Sₑ becomes small and Sᵤ becomes large as expected, so P₂ keeps the buffer for clustering. When P₂ starts executing at the beginning of t₂, the requests of P₁ are scattered and clustering P₂ does not save energy. Thus S_{c} is still small and Sᵤ also becomes small at the third arrow. Since clustering is no longer beneficial, P₂ stops clustering and releases the buffer. At the fourth arrow, S_{c} is still small so no buffer allocation is needed. After entering t₃, P₂ has terminated and S_{c} becomes large, P₂ thus allocates buffer again at the fifth arrow to cluster requests. At the six arrow, Sᵤ is large so the buffer is kept for clustering.

We can determine the size of the buffer for clustering as follows. Let T be the length of the period, B be the total bytes processed by the requests during the period, W be the power of each page (4096 bytes) of the memory. We then illustratively allocate x pages of memory buffer for prefetching. Then, after the x pages of data are consumed, the system wakes up the hardware component to refill the buffer. After the buffer is refilled, the component returns to the sleep state to save energy. The average number of wakeups per period of

$$T is \frac{B}{4096 x} .$$

The average energy overhead incurred per period of

$$T is \frac{B}{4096 x} ( {e}_{w} + {e}_{d} ) .$$

The buffer energy per period of T is xWT. We should allocate buffer to cluster requests if the following criteria is satisfied.

$${E}_{c} - \frac{B}{4096 x} ( {e}_{w} + {e}_{d} ) - xWT > 0$$

The left-hand side of the above equation is the net potential energy savings per period of T. By calculating the derivative of x, we find the maximum of the left-hand side is

$${E}_{c} - 2 \sqrt{\frac{BWT ( {e}_{w} + {e}_{d} )}{4096}} when x = \sqrt{\frac{B ( {e}_{w} + {e}_{d} )}{4096 WT}} .$$

By including this result, our adaptation decision is quantified as following: If

$${E}_{c} - 2 \sqrt{\frac{BWT ( {e}_{w} + {e}_{d} )}{4096}} > 0 ,$$

we allocate a buffer with size

$${E}_{c} - 2 \sqrt{\frac{BWT ( {e}_{w} + {e}_{d} )}{4096}} < 0 and$$

$${S}_{u} - xWT = {S}_{u} - \sqrt{\frac{BWT ( {e}_{w} + {e}_{d} )}{4096}} < 0 ,$$

for clustering. If

$$\sqrt{\frac{B ( {e}_{w} + {e}_{d} )}{WT}}$$

we deallocate the buffer if it has been allocated because clustering in this case saves no energy.

### EXAMPLES

An illustrated system and method of the present invention is implemented in Linux to discover the opportunities for energy reduction. The present system's energy accountant can accurately estimate the energy savings of workload adjustment, and the accounting information can guide workload adjustment at runtime to save more energy and achieve better energy efficiency. The energy efficiency is defined as the ratio of the amount of work to the energy consumption.

An illustrative embodiment of the present system and method has experimental board called Integrated Development Platform (IDP) by Accelent Systems running Linux 2.4.18. FIG. 22 shows the setup of one embodiment. The IDP provides probing points to measure the power consumption of individual components. The measurement is performed by a data acquisition card 120 illustratively from National Instruments. This card 120 can measure the power of 16 components simultaneously with a sampling rate up to 200 KHz. In the IDP, we install a Netgear wired or Orinoco wireless network interface card and an IBM Microdrive through two PCMCIA Extender cards. The Extender cards provide the probing points for power measurement. The IDP also allows measuring the power of the XScale processor.

We implemented a Linux kernel module to perform energy accounting. The input to this module is the starting and ending times of requests or idle periods of a hardware component 122. The timing information is obtained by inserting the kernel function “do_gettimeofday” into the process scheduler for the CPU or the device drivers for the I/O components. For the CPU, the request of a process is the duration between the time the process is switched in and the time it is switched out. For the other components, the request's duration is between the request starts to execute and completes. If several consecutive requests are from the same process, they are merged as one request. With the timing information of requests, the accountant reconstructs the relationship between processes and their energy consumption for estimating the potential energy reduction. The accountant module provides three APIs “get_sr (pid, cname)”, “get_sc (pid, cname)”, and “get_su (pid, cname)” to provide the estimations of potential energy savings by removal, potential energy savings by clustering, and current energy savings for a process on a component, respectively. The process's pid is obtained by calling the Linux function “etpid( )”. The component's “cname” is the device name defined in Linux, e.g., “/dev/hda” for the disk.

Table II shows the parameters of the four illustrated hardware components in our example: the IBM Microdrive, the Netgear full-duplex network card, the Orinoco wireless network card, and the Intel XScale processor. All values are obtained from the experiments. Our experiments do not set the processor to the sleeping state so we do not report the processor's values of t_{d}, T_{w}, e_{d}, and e_{w}. The break-even time is calculated by:

$$\frac{{e}_{w} + {e}_{d} - {p}_{s} ( {τ}_{d} + {τ}_{w} )}{{p}_{l} - {p}_{s}}$$

The Microdrive has two sleeping states s₁ and s₂. If the Microdrive's idle time is shorter than the sleeping state sᵢ's break-even time (0.65 seconds), the Microdrive should not sleep. If the idle time is longer than s₂'s breakeven time (1.05 second), the Microdrive may enter s₁ or s₂. As explained above, to determine which state to choose, the threshold where entering s₂ can save more energy is calculated.

Let t be the length of idleness. The energy by entering s₁ is e_{d,1}+e_{w,1}+p_{s,1}(t−T_{d,1}−T_{w,1})=0.124+0.207+0.24(t−0.159−0.273). The energy by entering s₂ is s e_{d,2}+e_{w,2}+p_{s,2}(t−T_{d,2}−T_{w,2})=0.135+0.475+0.066(t−0.160−0.716). The threshold is the value of t so that the energy is the same in either state 0.124+0.207+0.24(t−0.159−0.273)=0.135+0.475+0.066(t−0.160−0.716)→t=1.87. Therefore, the Microdrive enters s₂ only if the idle period is longer than 1.87 seconds (not s₂'s break-even time, 1.05 seconds). If the idle time is between 0.65 seconds and 1.87 seconds, the Microdrive enters s₁.

TABLE II

| | meaning | Microdrive | Netgear | Wireless | XScale |
|---|---|---|---|---|---|
| pₐ (W) | active power | 0.60 | 0.51 | 1.3tx, | 0.442 |
| | | | | 0.8rx | |
| pₗ (W) | idle power | 0.59 | 0.5 | 0.75 | 0.163 |
| pₛ (W) | sleeping power | 0.24/0.066 | 0.002 | 0.08 | 0.001 |
| T_{d} (s) | shutdown delay | 0.159/0.160 | 0.096 | 0.03 | |
| T_{w} (s) | wakeup delay | 0.273/0.716 | 1.9 | 0.06 | |
| e_{d} (J) | shutdown energy | 0.124/0.135 | 0.065 | 0.038 | |
| e_{w} (J) | wakeup energy | 0.207/0.475 | 0.326 | 0.079 | |
| t_{be} (s) | break-even time | 0.65/1.05 | 0.66 | 0.15 | |

The Measured Parameters of the IBM Microdrive, the Netgear Full-Duplex Network Card, the Orinoco Wireless Network Card, and the XScale Processor (PXA250). The Microdrive has Two Sleeping States, Shown as “s₁/s₂”. The Wireless Card has Two Operational Modes: Transmission (tx) and Reception (rx).

The application programs used in one illustrated example include: “madplay”: an audio player, “xmms”: an audio streaming program, “mpegplayer”: an MPEG video player, “gzip”: a compression tool, “scp”: a secure file transferring utility, “httperf”: a program retrieving web pages. These programs have different workload characteristics on different components to demonstrate that the present system and method is applicable in different scenarios.

The programs chosen for different illustrative embodiments are based on two considerations: (a) Offline experiments are used to show that the energy accountant accurately reports the potential energy savings and we use simpler workloads for easier explanation of the details of the workloads. (b) Online experiments are used to show that the energy accountant handles more complex workloads to improve energy reduction. We use up to five programs running concurrently. Several components are used in illustrated embodiments to demonstrate that the present system and method is applicable to different components. A two-competitive time-out shutdown policy [10A] is used for each component, i.e., the timeout value of each component is set to be its break-even time.

Accuracy of Estimation

1) Clustering Requests: In this illustrated embodiment, the energy accountant is used to predict the energy savings by clustering for two programs “xmms” and “scp” on the Netgear network card. The two programs run concurrently. Program “xmms” retrieves data from the server periodically and stores the data in a buffer of 400 KB. When the amount of data in the buffer drops below 40 KB, the program refills the buffer again. When the buffer is full, “xmms” stops using the network card. Program “scp” has no buffering. This embodiment keeps the average bit rate of both programs at 50 Kbps. The purpose is to show that, even at the same average data rate, the energy responsibilities of the two programs can be significantly different if they have different degrees of burstiness in their requests. This embodiment evaluates the accuracy of S_{c}, for the network card. Considering memory power to determine optimal buffer size is evaluated below.

FIGS. 23 (a)-(f) shows the potential and reported energy savings by clustering. In FIGS. 23 (a) and (b), “xmms” uses a 400 KB buffer while “scp” has no buffering. FIG. 23 (a) shows the power consumption of “scp” and “xmms”. The power for “scp” is nearly a constant while the power consumption for “xmms” concentrates in short durations. When “xmms” fills the buffer, the network card consumes a significant amount of power. When “xmms” stops filling the buffer, energy changes to “xmms” is zero. FIG. 23 (b) shows the potential energy savings by clustering. The first bar is the total energy consumption. The second bar is the energy consumed by “scp” and the third bar is the energy of “xmms”. The shaded region is the potential savings (S_{c}) by clustering. The mid-value of the estimation range of S_{c} is illustratively used. The last bar corresponds to the power manager. Because most idle periods are shorter than the break-even time, there are few opportunities for power management, as indicated by the short fourth bar in FIGS. 23 (b) and (d). These figures show that “scp” has a great potential, up to 72%, to save more energy by clustering. In contrast, “xmms” has little potential to save energy. We enlarge the buffer size of “xmms” to observe the energy reduction. As shown in FIG. 23(c), the power for “xmms” rises and falls less frequently because the time the buffer fills and depletes is doubled. FIG. 23(d) shows little overall energy reduction because there is little room to save more energy by clustering the requests from “xmms”. Only 3% energy can be saved by doubling the buffer. In contrast, if we allocate 400 KB for “scp” and maintain the same bit rate (50 Kbps), we can observe substantial energy reduction. In FIGS. 23(e) and (f), we can see the power of both “scp” and “xmms” rises and falls. The network card is idle when neither program is using the card. The overall energy consumption is reduced by nearly 73%, mostly from the opportunity of clustering the requests from “scp”. The error is thus (73%−72%)/72%=1.39%.

2) Process Removal: This illustrated embodiment uses three programs “gzip”, “scp”, and “httperf” running concurrently. The energy accountant estimates the range of energy savings from the Microdrive, the wireless network card, and the XScale processor for removing one of the processes. FIGS. 24 (a)-(c) shows the estimation and measurement results of the three components. These figures show the energy savings of the three components. The numbers 1, 2, and 3 in FIGS. 24 (a)-(c) indicate which process is removed: 1—gzip, 2—scp, and 3—httperf. If the estimated energy savings is a range, it is shown as a vertical line over the white bar and the white bar represents the middle value of the range. FIG. 24 (a) shows that the energy of the Microdrive can be reduced by 12.3% to 15.67% if “gzip” is removed and by 25.3% to 29.4% if “scp” removed.

The measured data shows that the actual energy savings are close to the middle value of the estimation range. Since “httperf” does not use the Microdrive, the estimated energy savings is zero. However, the measurement shows that there are small energy savings (2.3%) on the Microdrive if “httperf” is removed. This reason is that removing “httperf” expedites the execution of the other two processes on the processor and this further expedites the accesses of the two processes on the Microdrive.

Similarly, removing “gzip” results in small energy savings (2%) on the wireless network card even though “gzip” does not use the network. FIG. 24 (b) shows that removing “scp” can save up to 51% of the network card's energy while removing “httperf” can save only about 9% energy. This is because “scp” uses the network more frequently than “httperf”. FIG. 24 (c) shows the energy savings of the processor. Since we do not shut down the processor, the estimated energy savings from removing one process is the reduced service time multiplied by the difference between the active power and the idle power. The estimation is thus a single value instead of a range. The actual savings are less than the estimated values because the processor still runs instructions from other processes (including the Linux kernel).

Runtime Workload Adjustment

1) Adaptive Clustering: As discussed above, clustering a process may save little energy. Therefore, the memory buffer can be released for other programs, (b) the released memory may be turned off to save energy, and (c) the performance degradation due to clustering can be avoided. Another illustrated embodiment evaluates only the energy savings assuming the unused memory can be turned off to save power as suggested in [5A].

In this embodiment, “scp” is always running as the background process to upload data files from the Microdrive to a remote server. We choose “scp” because it has no stringent timing constraints. We perform clustering for “scp” on the Microdrive. A memory buffer is allocated to prefetch data from the Microdrive. The memory consumes 5×10⁻⁵ W for every page of 4 KB. The power is calculated using the SDRAM datasheet from the Micron website. We modified the program “scp” such that it periodically inquires from our energy accountant about the potential energy savings S_{c} and the current energy savings Sᵤ. The period is chosen as 10 seconds. A sensitivity analysis of this parameter will be performed is illustrated below.

The present method for clustering is described above. To test the effectiveness of the method under different degrees of concurrency, the other programs, madplay, xmms, mpegplayer, gzip, and httperf, are occasionally selected to execute concurrently with “scp”. The degree of concurrency indicates how many concurrent user processes are running. When the degree of concurrency is one, only “scp” is running. When the degree is higher, the other six programs are randomly selected to execute. For example, when the degree of concurrency is three, two other programs execute concurrently with “scp”. We divide the whole duration of the experiment into 300-second intervals and randomly determine a degree of concurrency for each interval. Five examples are provided with increasing average and maximum degree of concurrency. A 0.65 s timeout is used to shutdown Microdrive.

The present method is compared with the method (called clustering) that allocates memory buffer based on the requests of only an individual process [2A]. Method clustering does not use the accounting information, E_{c}, and Eᵤ, to adaptively deallocate and re-allocate the buffer for “scp”. FIG. 25 shows the energy savings of using clustering for different degrees of concurrency. The energy savings is normalized to the original workload's energy consumption as 100%. Method clustering saves more energy (47%) than the original workload. As the degree of concurrency increases, less energy can be saved by clustering because the concurrent processes create scattered requests. If “scp” continues clustering, little energy can be saved by the Microdrive and the network card. Meanwhile, energy is consumed by the buffer memory. In contrast, the adaptive method of the present invention informs “scp” to stop clustering and release the buffer memory when there is little energy savings, thereby saving more energy.

2) Dynamically Suspending Processes: In this embodiment, a process is suspended only when the suspension can save a significant amount of energy. We use an Orinoco wireless card to transfer data and measure the number of data bytes transmitted. Similar to the workload used for dynamic clustering, “scp” is used as the background process. It is assume that “scp” is a low-priority process and it can be suspended if at least 5% energy can be saved. In this embodiment, the energy accountant periodically (every 10 seconds) calculates the current energy savings (Sᵤ) and the potential energy savings (Sᵣ) from removing or suspending the requests of “scp”. We use the mid-value of the estimation range of Sᵣ. If S_{T} is larger than 5%, “scp” is suspended. If “scp” has been suspended and the current energy savings Sᵤ is less than 5%, “scp” is resumed. Occasionally, other programs are selected (madplay, xmms, mpegplayer, gzip, httperf) to execute concurrently with “scp”.

FIGS. 26 (a) and (b) show the energy savings and efficiency for removing or adaptively suspending “scp”. The efficiency is measured as the number of bytes transferred by all programs for every Joule. The efficiency is normalized to the original workload (with the degree of concurrency 1/1/1) as 100%. When the degree of concurrency is one and the requests are removed, over 92% energy can be saved as shown in FIG. 26 (a). However, the efficiency is zero as shown in FIG. 26 (b) because no data are copied by “scp”. As the degree of concurrency increases, “scp” can adaptively execute when the network card is in its idle state after serving the other programs. Even though the amount of energy saved by adaptation is less than removing “scp” as shown in FIG. 26 (a), the efficiency is significantly higher as shown in FIG. 26 (b). This is because we resume “scp” when the requests from other process are scattered on the network card so the energy during the scattered idleness is utilized to serve scp's requests. The original workload has high efficiency but it saves little energy. The experimental results show the importance of considering concurrent processes to achieve both significant energy savings and high efficiency.

3) Hybrid Workload Adjustment: In this embodiment, hybrid workload adjustment is performed by combining the adaptive clustering and suspension. The motivation is that clustering can finish more work than suspension so clustering is chosen when its potential energy savings is comparable to suspension. When Sᵣ is less than 5% (note that S,<Sᵣ), we do not perform either clustering or suspension. If Sᵣ is larger than 5%, we consider two cases: if S, (excluded the buffer energy) is within 5% of Sᵣ, we perform clustering; otherwise, we perform suspension. The experiment is performed on the Microdrive. The energy savings and efficiency of hybrid adjustment is compared with adaptive clustering and adaptive suspension.

FIGS. 27 (a) and (b) show the results. Adaptive suspension obtains the largest energy savings but its energy efficiency is as much as 100% lower than the other two methods. On the other hand, adaptive clustering obtains the best energy efficiency but its energy savings is as much as 40% lower than the other two methods. Hybrid adjustment takes advantages of the other two methods. It saves energy comparable to adaptive suspension and achieves energy efficiency comparable to adaptive clustering. The reason is that hybrid adjustment performs clustering when its potential energy savings are close to suspension and thus completes more requests than adaptive suspension.

The time overheads of the three methods are shown in FIG. 28. The overheads of these methods are measured as the total time for computing the energy responsibilities and the potential energy savings. The overhead is normalized to the computation time of the original workload without adjustment as 100%. The energy overhead is similar. Adaptive clustering handles more requests so its overhead is larger than the other two methods, as shown in FIG. 28. Adaptive suspension handles the least number of requests so its overhead is smallest. Hybrid adjustment is between the other two methods. When the degree of concurrency is one, both hybrid adjustment and adaptive suspension always suspend the single process. Their energy overheads are both close to zero because they handle almost no requests to the Microdrive. The overheads are increasing as the degree of concurrency increases. The reason is that more requests need to be handled for higher degree of concurrency. The highest overhead shown in the figure is 0.77%.

In all the illustrated runtime embodiments, an adaptation period of 10 seconds is used. The adaptation period should be small in order to catch the runtime change of workloads in time. However, it should not be too small because the instantaneous workload variation may not reflect the future workload characteristics. FIG. 29 shows the sensitivity of energy savings from hybrid adjustment to the adaptation period ranging from 2 seconds to 16 seconds. Among different degrees of concurrency, any period chosen between 6 and 12 seconds obtains higher energy savings.

The present system and method illustratively assigns energy responsibilities to individual processes and estimates how much energy can be saved when a process clusters or removes requests by considering other concurrent processes. Each process can be utilized such energy accounting information is used to improve its workload adjustment for better energy savings and efficiency. Energy savings and efficiency can be affected by the presence of other concurrent processes. The illustrative methods are effective especially when the degree of concurrency is high. An OS can be instrumental to provide across-process information to individual processes for better workload adjustment. A coordination framework that allows multiple processes to adjust their workloads simultaneously may also be provided using the features of the present system and method.

While this invention has been described as having exemplary designs or embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Although the invention has been described in detail with reference to certain illustrated embodiments, variations and modifications exist within the scope and spirit of the present invention as described and defined in the following claims.

What is claimed is:

1. A method for power management in a computer operating system, the method comprising:
providing a plurality of policies which are eligible to be selected for at least one hardware component;
comparing the plurality of eligible policies based on estimated power consumption for a current request pattern of the hardware component;
selecting one of the eligible policies to manage the hardware component based on the comparing step; and
managing the hardware component with the selected policy.

2. The method of claim 1, wherein the comparing, selecting and managing steps are conducted by the operating system without rebooting the system.

3. The method of claim 1, further comprising adding a new eligible policy.

4. The method of claim 3, wherein the adding step is conducted by the operating system without rebooting the system.

5. The method of claim 1, wherein the all eligible policies are compared simultaneously during the comparing step.

6. The method of claim 1, wherein the comparing step includes estimating an average power value for each eligible policy based on the current request pattern for the component, and the selecting step selects the policy with the lowest average power value.

7. The method of claim 1, wherein the comparing, selecting and managing steps are performed for a plurality of different hardware components.

8. The method of claim 1, wherein each of the plurality of policies determines when to change a component's power states and which power states to use to power the component in different ways from others of the plurality of policies.

9. A method for power management in a computer operating system, the method comprising:
providing a plurality of policies which are eligible to be selected for a component;
automatically selecting one of the eligible policies to manage the component; and
activating the selected policy to manage the component while the system is running without rebooting the system.

10. The method of claim 9, wherein the step of automatically selecting comprises comparing the plurality of eligible policies based on estimated power consumption for a current request pattern of the component and selecting one of the eligible policies to manage the hardware component based on the comparing step.

11. The method of claim 9, further comprising adding a new eligible policy without rebooting the system.

12. The method of claim 9, wherein the step of automatically selecting comprises estimating an average power value for each eligible policy based on the current request pattern for the component and then selecting the policy with the lowest average power value.

13. The method of claim 9, wherein the providing, automatically selecting, and activating steps are performed for a plurality of different hardware components.

14. The method of claim 9, wherein each of the plurality of policies determines when to change a component's power states and which power states to use to power the component in different ways from others of the plurality of policies.
